(19) United States
(12) Patent Application Publication
(10) Pub. No.: US 2008/0207357 A1
(43) Pub. Date: Aug. 28, 2008

(54) COMBINED RANGE AND TAG FINDER

(76) Inventors: Chris Savarese, Danville, CA (US); Noel H.C. Marshall, Gerringong (AU); Susan McGill, Redwood City, CA (US); Marvin Vickers, Quincy, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/027,978

(22) Filed: Feb. 7, 2008

Related U.S. Application Data
(60) Provisional application No. 60/900,582, filed on Feb. 9, 2007.

(51) Int. Cl. A63B 69/36; G01C 22/00; H04Q 5/22; F42B 6/04

(52) U.S. Cl. 473/407; 702/158; 340/568.6; 340/10.1; 473/578

(57) ABSTRACT

A combined range and tag finder for determining distances to objects in an environment is described. Such a combined range and tag finder includes a system for determining distances to objects on a golf course and for finding golf balls for use with a system for finding golf balls. In the case of one exemplary integrated device, the device has at least two receivers, one to receive an RFID signal from the golf ball, another to receive a signal for positioning of the device location. At least one processor is coupled to both the receivers and can determine at least a direction and/or distance of the device from an object on the golf course. Other embodiments of a combined range and tag finder are also described.

This application claims the benefit of the filing date of U.S. Provisional Application No. 60/900,582, filed Feb. 9, 2007, and this provisional application is incorporated herein by reference.

### FIELD OF THE INVENTION

The invention is related to outdoor activities, particularly golf and hunting, and more particularly to systems and devices to aid in these activities and devices and systems for use with tagged objects such as golf balls, arrows and bullets.

### BACKGROUND OF THE INVENTION

Golf balls are often lost when people play golf, irrespective of the level of skill of the player. Loss of the ball slows down the game as players search for lost balls and lead to frustrations on the players who hit the balls and for others who are waiting for the players to find the lost balls. Lost balls also make the game more expensive to play because of the cost of new balls. Furthermore, according to the rules of the U.S. Golf Association, a player is penalized for strokes in a round or game of golf if his/her golf ball is lost.

Estimating the distance between the ball and a target, for example, the hole on a putting green, is crucial to club selection. Selecting the club with the proper length and club head angle is important for hitting the ball to a target location at a particular distance away. Often times after a golf ball is teed off from the tee, the ball may land on the fairway, in the rough or in a hazard like a sand trap. Although there are yard markers or sprinkler heads on certain points along the course indicating the distance from the markers to the hole, they are spread wide apart and often far from where the ball landed.

There are individual attempts to make systems, devices and findable golf balls to alleviate the trouble of finding lost golf balls, and there are also commercially available range finders using laser or global positioning satellite (GPS) to determine distances between the user and an object on the course, but there is no integrated or combined device that can perform both tasks.

For example, an attempt to make a findable golf ball is described in German Patent No. G 87 09 503.3 (Helmut Mayer, 1988). In this German patent, a two-piece golf ball is fitted with foil reflectors which are glued to the outer layer of the core. The ball has a shell surrounding the foil reflectors and the core. The ball uses the signal transmitted from the user and doubling the frequency of the signal received using a diode back to the user's receiver. However, it has been discovered that this all foil antenna does not provide a durable antenna and that the ball will not be findable (e.g. findable for a distance of greater than 20 feet) after only a few hits on the ball.

Another attempt in the art to make a findable golf ball is described in PCT Patent Application No. WO 0102060 A1, which describes a golf ball for use in a driving range. This golf ball includes a radiofrequency identification device (RFID) which identifies a particular ball. The RFID includes an ASIC chip which is energized from a received radio signal. The RFID device is mounted in a sealed capsule which is placed within the core of the ball. The RFID device is designed to be used only at short range (e.g. less than about 10 feet). Other examples of attempts in the prior art to make findable golf balls include U.S. Pat. Nos. 5,626,531; 5,423,549; 5,662,534; and 5,820,484.

There are also other examples in the art to make a range finding system. For instance, one example is described in U.S. Pat. No. 5,056,106 (Wang et al., 1990). This system uses a spread-spectrum based radiolocation system, using a hand-held receiver unit and fixed position reference transmitters to determine distance and direction between a golfer and key locations on a golf course such as distance and direction to a particular pin. Each transmitter broadcasts at the same radiofrequency (RF) signal but the carrier is modulated by a unique pseudo-noise sequence. The distance and direction from the current position to any pin is calculated based on the comparison of stored coordinates of the reference transmitters, the pin positions, and other reference points for each hole on the golf course. Other examples of range finding devices can also be found in U.S. Pat. Nos. 5,797,809; 6,320,173; and 6,470,242. Lastly, there are commercially available devices made by, for example, Bushnell™, who uses laser to determine range distances, or Uplink™ and ProlinkGPS™ and SkyCaddy that uses GPS to determine range distances.

Hunting shares similar problems with golfing. In golf it is difficult to quickly locate a golf ball after it has been struck. In hunting it is difficult to quickly locate an arrow or bullet after it has been shot and missed the target or when the arrow or bullet is lodged in a wounded animal that escapes. In golf it is difficult to determine the distance away from objects (i.e. flag pole, the green, hazards, etc.) In hunting it is difficult to determine the distance away from the animal being hunted. Hunters would benefit from tagged arrows or bullets that could be similarly located with a handheld device.

There are significant problems that exist in bow hunting. When an arrow is released it is often difficult to locate the arrow. Arrows can be expensive and time is wasted searching for them. It is often difficult to determine whether or not an animal was struck by an arrow, whether or not the arrow is lodged in the animal, and whether or not the arrow struck an animal and passed through it. This uncertainty can cause significant search times (time that hunters would rather spend hunting for animals)—for both the arrow and the animal that may or may not have been struck by the arrow.

There are instances when an arrow is found that contains evidence that the arrowed struck, passed through and wounded the animal (i.e. blood from the animal on the found arrow). In these instances there are multiple reasons why it is desirable to locate the wounded animal. One reason is that wounded game should not be left to suffer if it can be avoided. Another reason is if there is evidence a hunter wounded an animal with an arrow, the hunter may not be permitted to shoot at another animal on that outing (similar to “catching a limit” in fishing). Therefore the hunter is motivated to find the animal that the hunter wounded. Hunting outings can be very expensive so the hunter has monetary incentive to locate the wounded animal. If an arrow is located and there is no evidence that the arrow struck an animal, this can avoid the uncertainty of whether or not a particular animal was struck and could save significant time searching for an animal that is not wounded.

There are known attempts to solve the bow hunting problems explained above. For example, a product called Tag-n-Trail attaches a tracking object just behind the broad head hunting point on a sage hook that detaches itself to the game animal when shot. See www.flexfletch.com/Tag-n-Trail.htm. However, it has been reported that this product is not effective.

Another example is United States Patent Application Publication No. 2005/0231362 titled “Apparatus carrying a mounted RFID circuit for the purpose of deploying and generating a tracking signal (post shot only) from an arrow” by Pridmore et al describes mechanical embodiment for the “tag” but does not explain in detail how to make the RFID technology work.

Besides golfing and hunting, it is understood that there are other activities that could also benefit from inventive embodiments described herein. Other prior art which may be related to finding an object include U.S. Pat. Nos. 5,298,904 and 6,908,404 and U.S. Patent Application Publication No. 2002/0188359.

### SUMMARY OF THE DESCRIPTION

Apparatuses and systems relating to an integrated range and ball finder are described herein.

In one exemplary embodiment of an aspect of the invention, a system for measuring distance and for locating a golf ball includes a golf ball and a portable device. The golf ball includes a semiconductor coupled to an antenna, both of which are encased within the hard outer shell of the golf ball. The portable device has a first receiver to receive a signal response from the golf ball and the first receiver can determine information about a location of the golf ball. The information may include distance and/or direction of the golf ball from the device relative to the golf ball. The portable device also contains a second receiver (e.g. a GPS receiver or a receiver to receive a laser's reflection) to determine information about a location of the portable device and a microprocessor coupled to both the first and the second receiver to determine the direction and/or the distance of a fixed object on the course relative to the portable device.

In another exemplary embodiment, a hand held device is integrated with the functions of finding golf balls and for measuring range distances relative to fixed objects on a golf course. This hand held device has a first receiver to receive a signal response from the golf ball and the first receiver can determine information about a location of the golf ball. The information may include distance and/or direction of the golf ball from the device relative to the golf ball. The handheld device also contains a second receiver to determine information about a location of the portable device and a microprocessor coupled to both the first and the second receiver to determine the direction and/or the distance of a fixed object on the course relative to the portable device.

In another exemplary embodiment, a method for measuring a distance and for locating a golf ball is described. A device receives a response in a first receiver from a golf ball having a semiconductor coupled to an antenna, where the golf ball is located within a predefined environment. The first receiver then determines the distance and/or direction of the golf ball relative to the device. The device then receives a second signal in a second receiver to determine information about a location of the device and then measure the distance and/or direction of the device relative to one or more fixed objects in the predefined environment, such as a golf course.

In yet another exemplary embodiment, an apparatus for measuring distance and for locating a golf ball includes a portable device and a cellular telephone. The portable device has a first receiver to receive a signal from a golf ball, upon receiving the signal, the first receiver can determine information about the location of the golf ball. This information includes the distance and/or direction of the golf ball relative to the portable device. The cellular telephone is electrically coupled to the portable device by at least one of a microprocessor and a common memory. The microprocessor has the capability to determine information about the cellular telephone relative to one or more fixed objects in a predefined environment. The information includes a distance and/or a direction of the fixed object relative to the cellular telephone. In one embodiment, the cellular telephone could have both range finding and ball finding capabilities without a separate portable device or accessory.

In still another exemplary embodiment, an apparatus for measuring distance and for locating a golf ball includes a portable device and a range finding device, the range finding device is coupled to a movable object in the predefined environment. A combined range finder and ball finder in this embodiment could be fixed to the cart or optionally removable from the cart. For example, a movable object can be a golf cart equipped with a satellite positioning system on the golf course. The portable device includes a first receiver to receive a signal from a golf ball, upon receiving the signal, the first receiver can determine information about the location of the golf ball. This information includes the distance and/or direction of the golf ball relative to the portable device. The range finding device is electrically coupled to the portable device through at least one of a microprocessor and a memory. This range finding device has the capability to determine the distance and/or direction of the movable object, or both, relative to any fixed object in the predefined environment.

In yet another different exemplary embodiment, an apparatus for measuring distance and for locating a golf ball is an integrated, portable device having the functions of locating a golf ball and measuring distances using a laser beam. This integrated, portable device has a first receiver to receive a signal response from the golf ball and the first receiver can determine information about a location of the golf ball. The information may include distance or direction of the golf ball, or both, from the device relative to the golf ball. The handheld device also contains a laser beam transmitter, a laser beam receiver, an internal clock and a view finder. The user can use the device to first locate a lost golf ball on the golf course, and then use the range finder at the location of the golf ball to measure the approximate distance between the golf ball and a fixed object on the course.

Still another exemplary embodiment is an apparatus for measuring distance and for locating a golf ball that has at least two receivers and laser capability. This apparatus is a portable device having a first receiver to receive a signal response from the golf ball and the first receiver can determine information about a location of the golf ball. The information may include distance and/or direction of the golf ball from the device relative to the golf ball. This portable device also contains a second receiver to determine information about a location of the portable device and at least one of a microprocessor and a memory is coupled to both the first and the second receiver to provide information about the location of the golf ball relative to fixed objects within the predefined environment such as a golf course. The portable device also contains a laser beam transmitter, a laser beam receiver, an internal clock and a view finder. The user can use this laser system to determine the distance between any fixed object on the golf course that is not provided with the information stored in the memory. Lastly, the device may also have data entry and data transmission capability for transmitting data to a location such as the club house in a golf course.

There is a need for a combined and integrated device that can both locate golf balls and determine range distances. Once a golfer hits the ball, the natural process is to find the ball and then hit again towards the target. If the range finder is a separate device from the ball finder, the golfer would have to purchase and carry an extra device, thus increasing the cost to play the game and the equipment to carry onto the golf course. With a combined ball and range finder, the golfer can use the integrated device to find a lost ball, switch mode to determine the distance, and select the proper club for his next shot. An integrated range and ball finder helps to expedite golf play on the course while making the game of golf more friendly and enjoyable for players of all skill levels.

Other embodiments of range and tag finders and methods of making such devices and systems are described. Other features and embodiments of various aspects of the various inventions will be apparent from this description.

### BRIEF DESCRIPTION OF THE DRAWINGS

The present invention is illustrated by way of example and not limitation in the figures of the accompanying drawings in which like references indicate similar elements.

FIG. 1A shows a ball finding capability of a ball and range finder system according to one embodiment of the present invention.

FIG. 1B shows a range finding capability of a ball and range finder system according to one embodiment of the present invention.

FIG. 1C shows both the ball finding and range finding capabilities of a ball and range finder system according to one embodiment of the present invention.

FIG. 2A shows a block diagram of electrical components in one embodiment of a findable golf ball.

FIG. 2B shows a cross-sectional view of a two-piece golf ball with a tag and antenna between the core and the shell of the golf ball.

FIG. 2C shows a dissected perspective view of the golf ball shown in FIG. 2A.

FIG. 2D shows a cross-sectional view of a three-piece golf ball with a tag and antenna between the core and the middle layer of the golf ball.

FIG. 3 shows a golf ball with three parts having electrical components inside its micro-core according to one embodiment of the present invention.

FIG. 4 shows electrical components responsible for ball finding in the integrated ball and range finder according to one embodiment of the present invention.

FIG. 5A shows electrical components responsible for using a satellite positioning system for range finding in the integrated ball and range finder according to one embodiment of the present invention

FIG. 5B shows electrical components responsible for using laser beam for range finding in the integrated ball and range finder according to one embodiment of the present invention.

FIG. 6A shows one embodiment of range finding using a satellite positioning system that relies on earth orbiting satellites.

FIG. 6B shows one embodiment of range finding using a satellite positioning system that relies on a cellular network of ground transmission towers located at various points on earth.

FIG. 7A shows electrical components for both ball finding and range finding in an integrated ball and range finder in one embodiment according to the present invention.

FIG. 7B shows electrical components of RFID receiver/transmitter of the integrated ball and range finder illustrated in FIG. 6A.

FIG. 8 shows an example of representations of predetermined locations and fixed objects located about a golf course according to one embodiment in the present invention.

FIG. 9 shows an example of content in the memory in the integrated ball and range finder in one embodiment of the present invention.

FIG. 10 shows electrical components of a ball finder that can be electrically coupled to a cellular telephone to operate as one integrated ball and range finder according to one embodiment of the present invention.

FIG. 11A shows electrical components of a ball finder that can be electrically coupled to an independent range finder to operate as one integrated ball and range finder unit according to one embodiment of the present invention.

FIG. 11B shows an independent range finder using satellite positioning system for range finding to be electrically coupled to the ball finder in FIG. 11A.

FIG. 11C shows an independent range finder using laser beam for range finding to be electrically coupled to the ball finder in FIG. 11A.

FIGS. 12A and 12B show a flow chart of the operation of an integrated ball and range finder in one embodiment of the present invention.

FIG. 13 shows a flow chart of the operation of an integrated ball and range finder in a different embodiment of the present invention.

FIGS. 14A and 14B show an arrow with a tag permanently coupled and detachedly coupled in accordance with the present invention. FIG. 14C shows a tag detachedly coupled to an arrow in accordance with the present invention.

### DETAILED DESCRIPTION

The subject invention will be described with reference to numerous details set forth below, and the accompanying drawings will illustrate the invention. The following description and drawings are illustrative of the invention and are not to be construed as limiting the invention. Numerous specific details are described to provide a thorough understanding of the present invention. However, in certain instances, well known or conventional details are not described in order to not unnecessarily obscure the present invention in detail.

Various embodiments and aspects of the invention will be described with reference to details set below, and the accompanying drawings will illustrate the invention. The following description and drawings are illustrative of the invention and are not to be construed as limiting the invention. Numerous specific details such as sizes and weights and frequencies are described to provide a thorough understanding of various embodiments of the present invention. However, in certain instances, well-known or conventional details are not described in order to not unnecessarily obscure the present invention in detail.

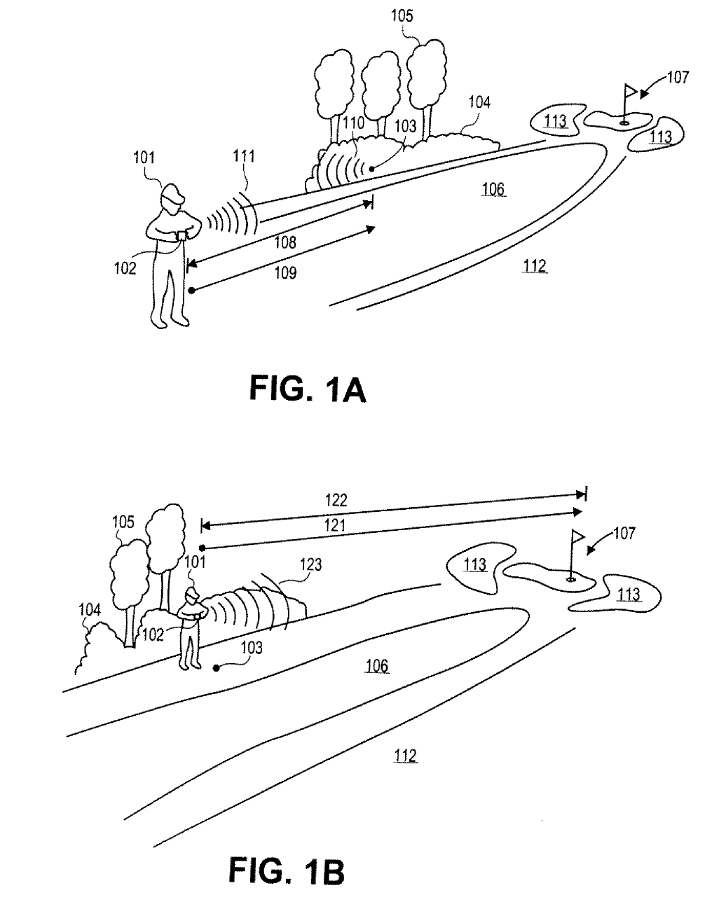

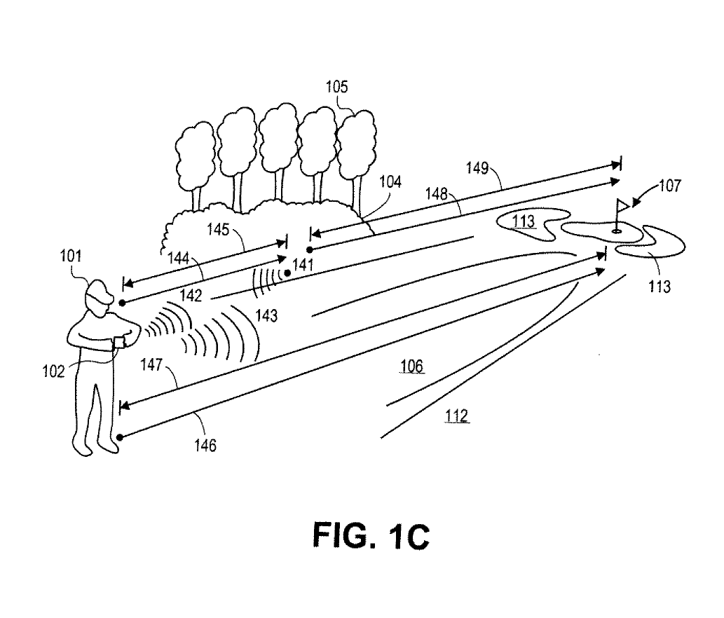

An integrated ball and range finder of various embodiments will be described in the following specification. FIGS. 1A and 1B illustrate the independent functions of ball finding and range finding of the integrated device respectively, while FIG. 1C illustrates the combined ball finding and range finding capability of the device.

FIG. 1A shows an example of the system which uses an integrated ball and range finding handheld transmitter/receiver to find a findable golf ball. A person 101, for example, a golfer, may carry a handheld transmitter/receiver 102 which is designed to locate a findable golf ball 103 which includes a tag that is embedded in the golf ball. This occurs, for example, when a golf ball 103 lies amongst bushes 104 and trees 105 far away from the fairway 106 of a golf course, such as in the rough 112 or areas of tall grass, rendering the findable golf ball 103 to be out of the direct line of vision of the person 101. In one embodiment of the present invention, the findable golf ball 103 is active and can intermittently or continuously transmit an electromagnetic signal. In other words, the findable golf ball has an active tag contained inside the findable golf ball 103 and the tag actively emits an electromagnetic signal 110 which can be received and modified. The integrated hand held device 102 possesses at least one receiver and antenna coupled to the microprocessor, memory, and power source to readily seek out, receive and modify the signal being transmitted from the findable golf ball 103. Therefore, in this example, the findable golf ball 103 acts as a transmitter and the integrated handheld device 102 acts as a receiver.

In a different embodiment, the findable golf ball 103 is passive and does not have an active tag that continuously or intermittently transmits an electromagnetic signal from the findable golf ball 103. Instead, the integrated device 102 actively transmits an electromagnetic signal 111 to seek out the findable golf ball 103. Upon reception of the electromagnetic signal 111, the passive or semi-passive tag inside the findable golf ball 103 can modify the frequency and transmit it back to the integrated handheld device 102 in response. In this example, the integrated handheld device may contain a transmitter and a receiver, or a transceiver for both transmitting and receiving signals, while the tag encased inside the golf ball contains an electrical component such as a diode or an integrated circuit that is coupled to the antenna.

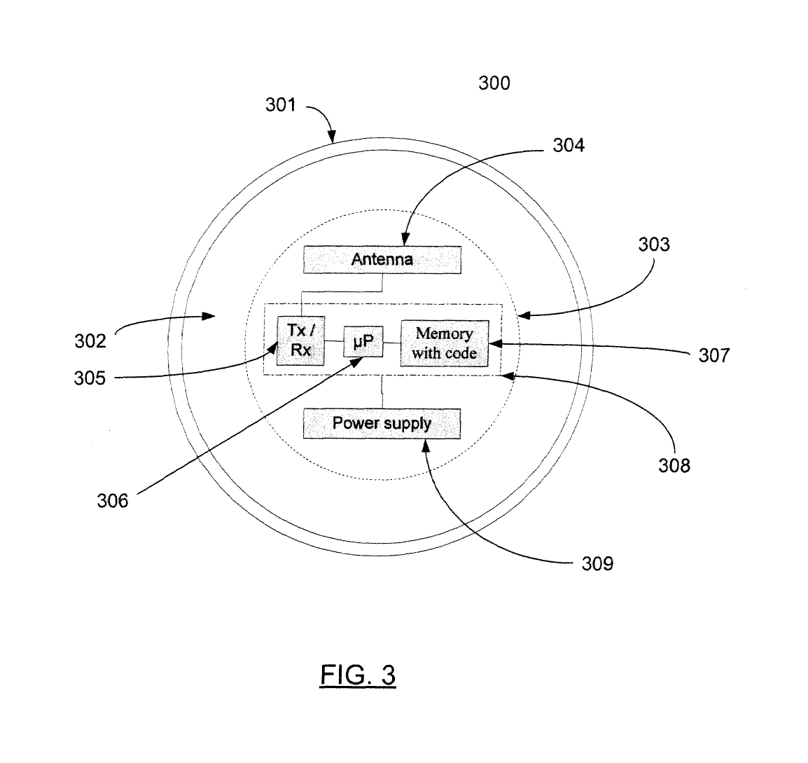

In both embodiments, the integrated device 102 can determine the direction 109 and/or distance 108 between the integrated handheld device 102 and the findable golf ball 103. The determination of the distance and/or direction is by determining the signal strength or the time it takes for the signal to travel, between the integrated handheld device 102 to the findable golf ball 103. Alternately, the phase difference between the transmitted signal and the received signal may also be used to determine the time of travel of the signal. Radio frequency identification (RFID) tag is a common implementation of the golf ball finding component of the system. However, other systems such as satellite positioning systems (SPS), like GPS (global positioning satellite) may also be possible. In an embodiment of this ball finding system, the findable golf ball has a unique or quasi unique identification. In one example, the unique or quasi unique identification is made possible by storing a unique or quasi unique identification in the memory in the golf ball. This feature will be further discussed below in FIG. 3.

FIG. 1B shows an example of the system which uses an integrated ball and range finding handheld transmitter/receiver to find a distance and/or direction of a fixed object in a predefined environment, such as a golf course. Upon locating the findable golf ball 103 using the ball finding system, as illustrated in FIG. 1A, the golfer 101, holding the handheld device, walks to and stands over the findable golf ball 103 and determines the direction 121 and/or the distance 122 from a target such as putting green 107. Similarly, the user can use the integrated handheld device to measure the distance of fix positioned hazards, such as sand traps 113 that are situated on either side of the putting green 107.

There are different methods in determining the distance and direction of a fixed object in a predefined environment, such as a golf course. Some of these methods are discussed briefly herein and further described in the specification below. In one embodiment, the coordinates of the movable integrated handheld device 102 are retrieved from a SPS each time the range finding function is activated. The SPS may be in the form of GPS satellites or a multitude of cellular signal transmission towers. The coordinates of the handheld device are directly trilaterated from GPS satellites or triangulated by multiple cellular signal transmission towers. Once the coordinates are determined, they can be compared against coordinates of fixed objects on a map that are predetermined and stored in a memory of the integrated device. The distance and direction of the fixed object(s) relative to the handheld device can then be calculated.

In a different embodiment, the distance can be determined by using a laser beam transmitter and receiver inherently built into the integrated device. The distance is determined by calculating the time elapsed for a beam of laser 123 to travel from the transmitter in the integrated handheld device 102 to the target 107 and back to the receiver in the integrated handheld device. In combination with a built in compass, for example, both the direction and distance can be determined.

FIG. 1C shows an example of the system which uses an integrated ball and range finding handheld transmitter/receiver to find a distance and/or direction of a findable golf ball, for example, relative to another fixed object, in a predefined environment, such as a golf course. Similar to the example in FIG. 1A, a golfer 101 has lost his findable golf ball 103 amongst the bushes 104 and the trees 105. The golfer 101 uses the integrated handheld device 102 to locate the direction 144 and/or distance 145 from the integrated handheld device 102 to the findable golf ball 103 as described in FIG. 1A. Upon locating the findable golf ball 103, the golfer 101, who is not at the location of the findable golf ball 103, determines the distance 147 and/or direction 146 of a fixed object, such as the putting green 107, from the integrated handheld device 102. This is conveniently accomplished by determining the coordinates of the handheld device 102 using a satellite positioning system and then making a calculation based on the fixed objects' predetermined coordinates pre-stored in the device's memory. Once the distances 145 and 147 (from the integrated device to the findable golf ball and the fixed object respectively) and the directions 144 and 146 (from the integrated device to the findable golf ball and the fixed object respectively) are determined, the distance 149 and direction 148 from the findable golf ball 103 can be calculated. Advance determination of the distance and direction between a findable golf ball and a fixed object is desired when the ball is hidden away from a golf cart or from the fairway and the golfer wants to make a club selection before approaching the ball for his next shot.

The integrated ball and range finder is designed to be used with a findable golf ball. The findable golf ball can have various different configurations such as a two-piece or three-piece configuration. Various embodiments of a findable golf ball may be used, for example, with RFID. Examples of findable golf balls and transmitting, receiving devices that transmit electromagnetic energy are described in U.S. patent application Ser. No. 11/264,177 titled “Apparatuses, Methods, and Systems Relating to Findable Golf Balls” by inventors Chris Savarese et al., filed on Oct. 31, 2005 and U.S. patent application Ser. No. 11/248,766 titled “Methods and Apparatuses Related to Findable Golf Balls” by inventors Chris Savarese et al., filed on Oct. 11, 2005. Both of these application disclosures are herein incorporated as reference at least for the purpose of describing such findable golf balls.

Findable golf balls vary in structural and material configurations compared to regular golf balls. However, the findable golf ball has substantially the same weight and size as the golf balls without the internal electrical components. Findable golf balls, just like regular golf balls, comply with the specifications of typical golf balls as specified by the United States Golf Association (USGA) and/or the Royal & Ancient Golf Club of St. Andrews (“R&A”). The tag within the findable golf ball is typically positioned such that the symmetry of the ball is substantially maintained. For example, the center of gravity and symmetry of a findable golf ball with a tag is substantially the same as a golf ball without a tag. The tag in certain embodiments is of such a weight and size so that the resulting ball containing the tag has the same weight and size of regular golf balls. The various parts of a tag may be made with materials which are designed to match the density specific gravity of the materials within the golf ball which are displaced by the tag. Furthermore, the findable golf ball possesses the same performance characteristics as other golf balls approved for use by the USGA and the R&A.

The functionality and description of a combined range and tag finder, as one integrated device, when applied, for example, to a bow hunting arrow application can be similar to the system described in FIGS. 1A-C. In one embodiment, a tag is coupled to an arrow and once the arrow is shot, the shooter may use the combined range and tag finder to find the tag that is coupled to the arrow. In an embodiment a tag is permanently implanted in an arrow, particularly the head portion of the arrow. Once the arrow is shot, the shooter can use the combined range and tag finder to determine the distance from the combined device to the arrow head. In another embodiment, the tag is coupled to the arrow and the tag detaches from the arrow after the arrow has hit its target, thus leaving only the tag behind with the target even though the arrow may pass through the target so the distance between the combined device from the target can be estimated and the location of the target found. Similarly, this system of a combined range and tag finder may be applied to model rockets and model airplanes where the tag can be coupled to the flying object (model rocket and model airplane). With the tag, the flying object can be tracked and located using the integrated combined range and tag finder.

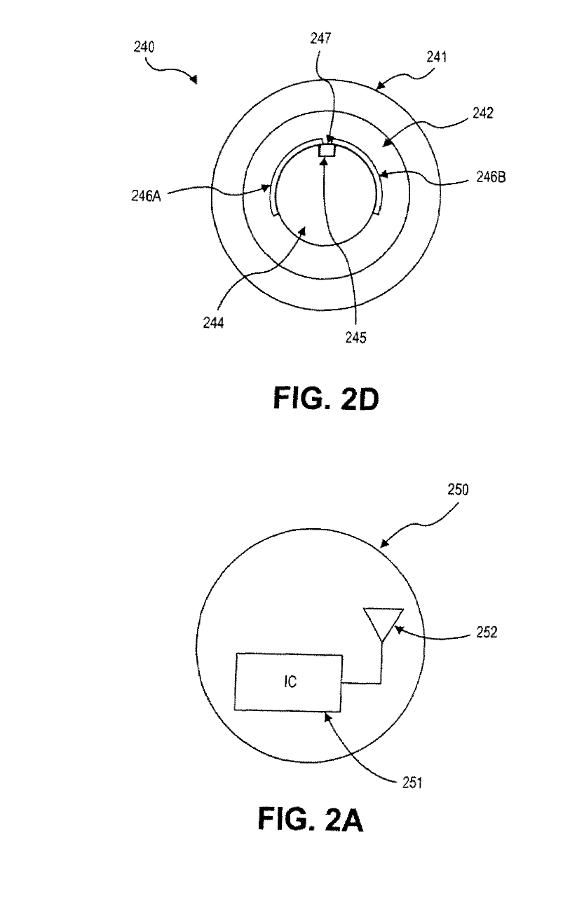

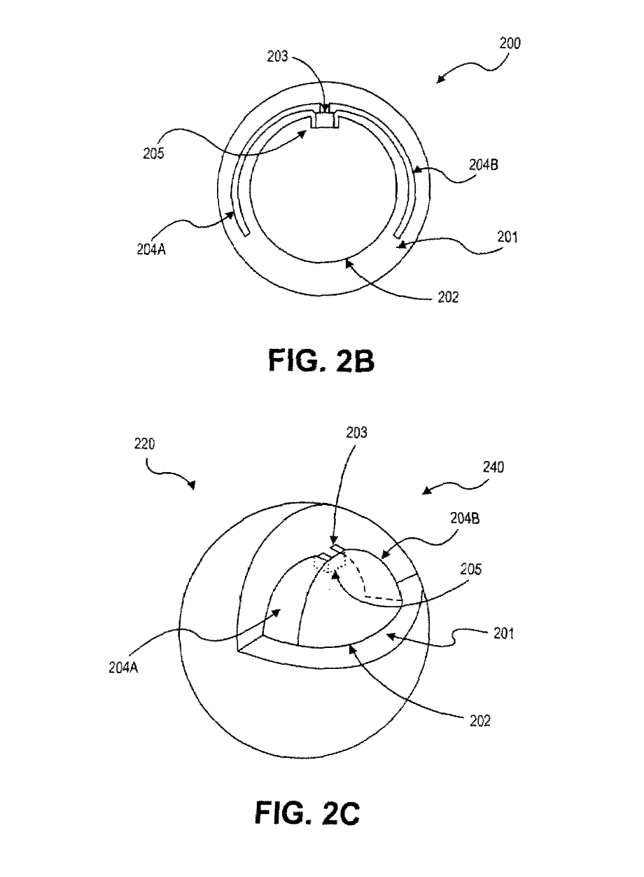

FIG. 2A shows the electrical components of a findable golf ball in one embodiment of the current invention. A findable golf ball 250 in its simplest form has at least two electrical components within the ball. There is an antenna 252 electrically coupled to an integrated circuit (IC) 251. In this example of a simple findable golf ball, the ball is passive and does not actively emit any electromagnetic signals. Instead, the IC 251 detects an electromagnetic signal, such as a radiofrequency (RF) signal emitted from a handheld ball finder (not shown), doubles the detected frequency of the RF signal, and resends the RF signal with doubled frequency back to the handheld device.

FIG. 2B shows a cross-sectional view of a two-piece findable golf ball. The findable golf ball 200 includes a core material 202 and a shell 201 which surrounds the spherical core material 202. A tag is disposed between the inner surface of the shell 201 and the outer spherical surface of the core material 202. The tag includes a semiconductor device such as a diode 203 which is coupled between antenna portions 204A and 204B. The diode 203 or other semiconductor device is disposed at least partially in a void or cavity 205 in the core material 202. The void 205 in the core material 202 helps to protect the diode 203 or other semiconductor device during the manufacturing process and helps to protect the diode from harm when the golf ball is struck by a golfer. Furthermore, the void also tends to keep the diode properly positioned and coupled to the antenna when the ball is manufactured and to prevent the diode from being disconnected from the antenna. The diode 203 or other semiconductor device is electrically coupled to the antenna portions 204A and 204B through electrical contact pads (not illustrated). FIG. 2C shows a dissected perspective view of the golf ball as illustrated in FIG. 2B. The golf ball 220 is shown in three dimensions with the shell layer 201 dissected, exposing the core layer 202. The two portions of the antenna 204A and 204B are shown to be attached to the diode 203 or other semiconductor device which is disposed at least partially within a void 205 or cavity in the core 202.

In another embodiment, such as FIG. 2D, a findable golf ball can be made of three or more pieces. For example, the findable golf ball 240 has a core 244 which is surrounded by a middle layer (or mantle) layer 242, which in turn is surrounded by an outer shell 241. As illustrated, the tag is enclosed within the middle layer 242 and over the core 244. However, the tag can also be enclosed between the middle layer 242 and the outer shell 241. The tag includes a diode 247 as well as antenna portions 246A and 246B. Preferably, the diode is also disposed within a void or cavity 245 for protection. Similar to the two piece configuration, the antenna portions of the tag can be made of an elastic conductive material such as conductive ink. In one embodiment, the conductive ink can be a polymer with metal particles disposed or dispersed in the polymer. The flexibility and elasticity of the antenna will allow the antenna and tag to withstand tremendous stress placed on a golf ball when it is hit by a golfer.

Different types of findable golf balls may differ from each other based on their electrical components and thus their functions. In one embodiment, as described in FIG. 1A, the findable golf ball can actively emit an electromagnetic signal at either intermittent or continuous intervals. FIG. 3 shows one embodiment of a findable golf ball capable of actively emitting an electromagnetic signal. Findable golf ball 300 has a micro-core 303 that is surrounded by a core 302, which in turn, is surrounded by an outer shell 301. Instead of a diode, this findable golf ball contains an integrated circuit (IC) 308 that includes a microprocessor 306, a memory 307 with computer code or programmed instructions, and at least a transmitter 305. The IC 308 is also electrically coupled to a power supply 309 that powers the microprocessor 306, the memory 307 and the transmitter 305. In one configuration, the power source can come from a non-rechargeable battery, for example, an alkaline battery similar those used in watches, or a rechargeable battery (e.g., a lithium ion battery) by solar power, magnetic induction, RF pulse, or by application of mechanical force. In one embodiment, the findable golf ball only transmits electromagnetic signals, and will include only a transmitter. However, as illustrated, a findable golf ball 300 may also have a receiver component in addition to the transmitter component, forming a transceiver 305, so that the findable golf ball can also receive electromagnetic signals from a handheld ball finder, and in response, transmit a modified signal or a different electromagnetic signal announcing its location.

In one embodiment, the memory stores the unique identification of the golf ball. For example, the memory can store one of a very large number of identification numbers (e.g., over a million), thus making the identification of the ball unique. Or, the memory can store one of a large number of identification numbers (e.g., over a hundred), thus making the identification of the ball quasi unique. With a large number of identification numbers, the likelihood of that number coinciding with another golf ball with the same identification number on the same part of the golf course at the same time is possible, but remote. In one embodiment, the memory 307 with code stores programmed instructions controlling the regularity of electromagnetic signal transmissions and works in conjunction with the handheld device to operate the microprocessor 306. Another embodiment may include unique programmable instructions on how to modify the frequency in response to a received electromagnetic signal from a handheld device to provide a unique identification of the findable golf ball. Typically, instructions are programmed and cannot be modified, but there may be embodiments where programmed instructions can be modified.

In one embodiment, the microprocessor 306 acts to control the interval in which the electromagnetic signal is emitted from the transmitter. The instructions and the microprocessor 306 thus indirectly control the level of power consumption of the golf ball. In another embodiment, the microprocessor 306 also acts to control the traffic flow of information to and from the memory, which in turn, can prioritize the execution of instructions and control power consumption while managing the data flow.

In one embodiment, the microprocessor 306 and the memory 307 of the golf ball 300 operate in conjunction with the handheld device to store information about the locations of the golf ball during play. This provides valuable historical data of a golfer's performance by allowing a golfer to review distances hit, coordinates of where the ball had landed and general trajectory of the ball based on the changing coordinates of the ball during the flight path. This is made possible in several ways. In one way, the receiver on the findable golf ball can intermittently receive information about the coordinates of the golf ball in flight, provided that the golf ball has SPS receiving capabilities. Another way is if there are numerous RFID readers that can transmit RFID signals from fixed locations about the golf course. The changing coordinates of the ball during its flight path can be recorded and thus the flight path and trajectory of the golf ball can be recreated. In another way, when an accelerometer and force transducer (not illustrated) are incorporated into the findable golf ball, the striking force of the golf club against the ball can be calculated. Similarly, the velocity of travel, the amount of spin on the ball resulting from the club strike can all be calculated and recorded by the microprocessor 306 and the memory 307. Therefore when the ball is stationary, all the acceleration and velocity information is zeroed, but from the moment when the ball is struck by the club until it comes to rest, the accelerometer and force transducer can record the changing information, calculating a flight path of the ball. A findable golf ball having a microprocessor, a memory, and a power source can provide a wide range of applications that can be directed to not only identifying a findable golf ball, but also can track the movement of the golf ball and thus help a golfer understand and improve his overall golfing game.

Similar to including tags in golf balls, tags attached to flying objects including, but not limited to arrows and bullets, may be physically small, light weight, durable and not adversely affect the flight of the flying object. Therefore, when a tag is applied to an arrow, the tag may also be physically small, light weight, durable and not affect the flight of the arrow. A tag to be used in either an arrow or a bullet can be similar to the tag as configured in FIG. 3. Also, the tag can be as simple as the one shown in FIG. 2A, comprising an integrated circuit and an antenna without memory or power supply.

The tag as described for a flying object may be permanently coupled to a flying object or detachedly coupled to a flying object. In one embodiment, the flying object is an arrow. The tag may be permanently attached to the arrow such as the shaft or the nock of the arrow that are on the rear portion of the arrow, or, it can be attached to the arrow's head or tip or in the front portion of the arrow. For example, a tag may be in the form of a sticker and simply adhered onto the arrow. Examples of tags that are powered by thin-film batteries or solar power are described in U.S. Patent Application Ser. No. 60/850,993 titled “Method And System For Powering Radio Frequency Identification Tags And Labels” by inventor Chris Savarese filed on Oct. 10, 2006 and in U.S. Patent Application Ser. No. 60/876,714 titled “Methods And Apparatuses For Activating And Powering Radio Frequency Identification Tags And Labels” by inventors Chris Savarese et al. filed on Dec. 21, 2006. Both of these U.S. patent applications are hereby incorporated as reference at least for the purpose of describing such active tags.

A permanent attachment to the arrow is particularly effective when broad head hunting points are used. Broad head hunting points are designed to stay in the animal when the arrow head strikes the animal. This can be accomplished by having additional broad head material release upon impact. For example, the arrow tip can extend to widen itself after impact, creating more friction and slowing the arrow down sufficiently so the arrow does not pass through the animal. The RFID tag can be attached to this type of broad head for hunting.

In another embodiment, the tag can be detachedly coupled to the arrow. When an RFID tag is attached to arrow (i.e., the shaft or the nock), the problem is that the arrow may enter and pass through the animal entirely or the may skirt and wound the animal without actually attaching to the animal. Further, a partially lodged arrow may be pried out or broken from the animal, and the tag may either be broken or left with the broken off portion that does not lodge in the animal as the animal runs through the trees and bushes. In these cases, a tag that is detachedly coupled to the arrow shaft may allow the tag to remain with the animal and thus allow the wounded animal to be tracked and located. For example, a tag can be permanently attached to a hook which is in turn detachably coupled to an arrow shaft. When the arrow hits or skirts the animal, the hook can attach onto the hide of the animal and thus allow for the tracking of the animal.

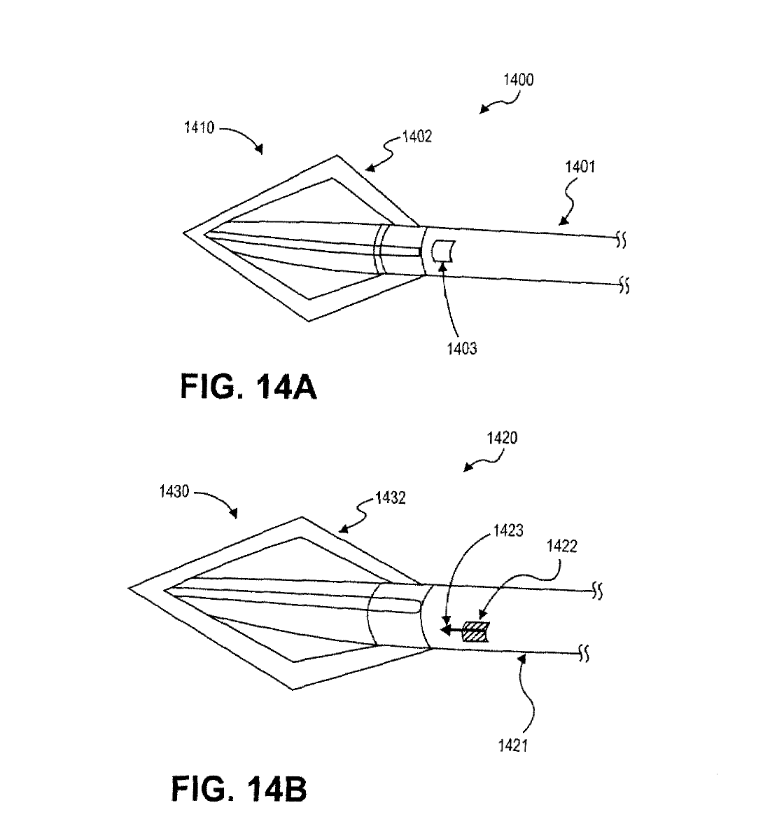

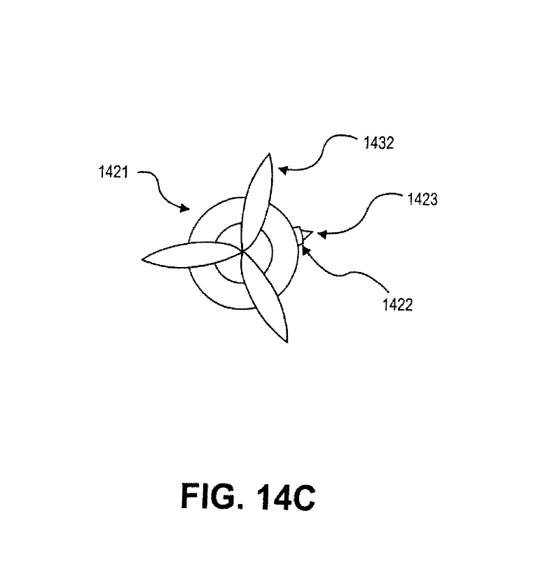

FIGS. 14A and 14B illustrate arrows with a permanently coupled tag and a detachedly coupled tag respectively. The arrow 1400 in FIG. 14A has an arrow head 1410 with cutting blades 1402 and the arrow shaft 1401. The RFID tag 1403 can be permanently fixed onto the shaft near the arrow head 1410 or be located on a blade 1402 of the arrow. Alternately, the RFID tag may also be permanently coupled to any where along the shaft of the arrow, for example, such as near the middle or the end of the arrow. As described, a broad head can be used to prevent the arrow from passing through the animal. It should be noted that the tag may be integrated into a part of the arrow and preferably the part of the arrow that will enter and can be lodged inside the animal's body. FIG. 14B shows an arrow with an arrow head 1430 with cutting blades 1432 and an arrow shaft 1421. The RFID tag is hidden inside the structure 1422 which is in turn attached to a hook 1423. The structure 1422 is permanently attached to the hook 1423 but detachedly coupled to the arrow shaft. It should be noted that the structure 1422 and the hook are not directly in line with the cutting blades 1432 but instead is staggered relative to them. The idea is that the hook will grab onto the animal's hide when the arrow pierces through the body of the animal and the tag and hook will attach onto the hide or skin or outer layer of the animal. It should be noted that a different form of a detachedly coupled tag can be used in place of a hook. FIG. 14C shows a frontal view of the arrow with a detachable tag. This view shows that the structure 1422 is permanently attached to the hook 1423 and both are detachedly coupled to the shaft 1421. The structure 1422 and the hook are also staggered relative to the blades 1432 and they are not directly lined up so that when the blade 1432 enters an animal, the hook 1423 can still grab or hook onto the animal's hide, fur, skin or flesh without following the path of the blade 1432 where a large wound or opening may be created.

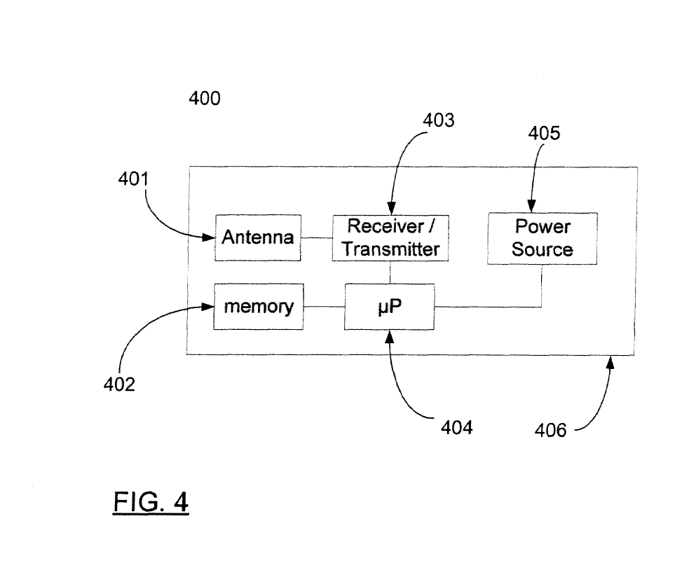

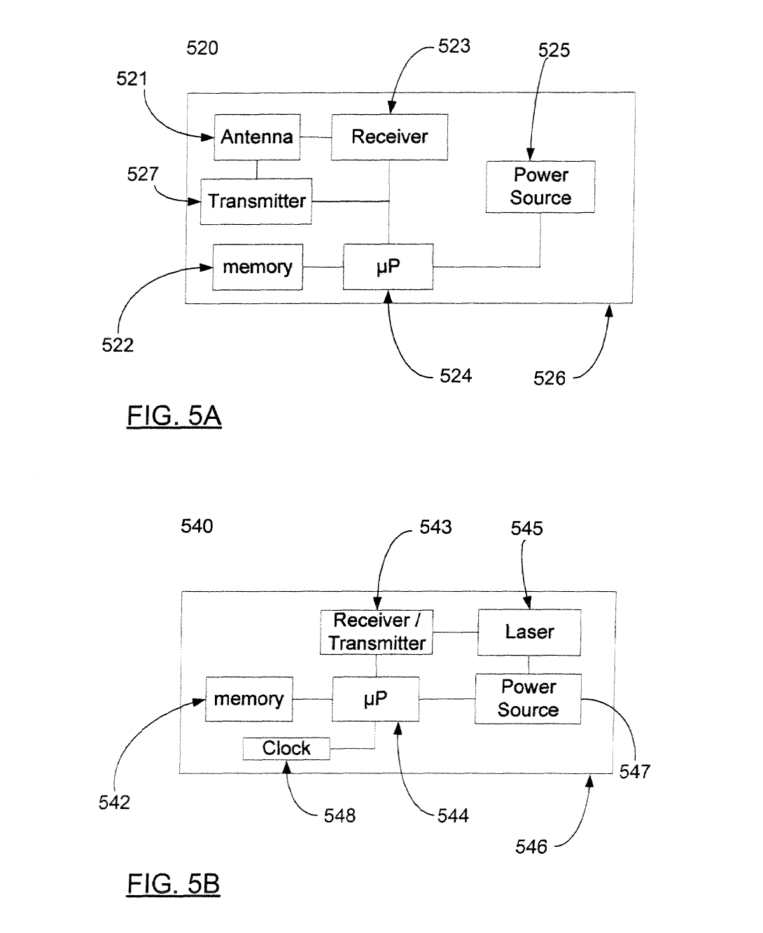

Returning to the description of an integrated ball and range finder. The integrated ball and range finder is designed to find a golf ball and measure the distance and/or direction from the device and/or the golf ball to a fixed object on a golf course. In one embodiment, the integrated handheld device can be broken down into two groups of components each performing a different function—ball finding and range finding. FIG. 4 shows an example of a first component of the integrated device performing a ball finding function, while FIGS. 5A and 5B show two examples of a second component of the integrated device performing a range finding function. Illustrations in FIGS. 4, 5A and 5B can also be directly applied to an integrated range and tag finding system for a flying object.

FIG. 4 shows the basic configuration of electrical components for the ball finding device function in an integrated handheld device. The ball finding component 400 of the integrated handheld device, in one embodiment, includes a microprocessor 404 electrically coupled to a memory 402, a power source 405, and a receiver 403, which in turn is coupled to an antenna. A most basic configuration of the ball finding component will only include a receiver because of the compatibility with a findable golf ball that actively emits an electromagnetic signal. In this configuration, the ball finding component of the integrated handheld device can determine the direction and distance of the golf ball from the device based on the strength of the electromagnetic signal which it detects. The microprocessor 404 is electrically coupled to the receiver 403, the power source 405, and the memory 402 which can be all shared with the range finding component of the integrated handheld device.

The microprocessor 404 processes and controls the flow of information. For example, as the electromagnetic signal is received in the receiver, the strength of the signal is determined and processed. The resulting information is stored in the memory 402 while the microprocessor 404 makes calculations to determine the distance and direction of the findable golf ball based on the strength of the electromagnetic signal received from the findable golf ball. The power source of the integrated device can be in the form of rechargeable batteries such as lithium ion batteries or non-rechargeable batteries. The batteries can be solar powered, rechargeable using the rechargeable battery of driving the golf cart or by an alternating current power source. The power source 405 can also be electrically coupled to the range finding component to provide energy to power both the ball finding and range finding components. The microprocessor 404 can be dedicated to the ball finding component or shared with the range finding component.

In another embodiment, the receiver 403 may perform both transmission and receiving functions. Thus, the receiver 403 can be a transceiver. In a transceiver configuration, the handheld device can in turn actively transmit electromagnetic signals while in searching mode for the findable golf ball, and it will expect a unique or quasi-unique response to identify the findable golf ball that was used by the particular golfer.

In one embodiment, the memory 402 of the integrated handheld device is unique and can be programmed to store at least a range of programmable unique or quasi-unique identification numbers to identify different findable golf balls. In another embodiment, the memory can also be used to store the various locations of the findable golf balls as they are found. Recording the locations of the golf balls can assist the golfer in keeping track of how far and where he hit his shots. In another embodiment, the memory 402 can store information including the course map, topographical information for each hole and each putting green, tips on how to play a specific golf course and even locations of the nearest refreshment stands and restrooms. In one embodiment, the memory 402 can also be shared with the range finding component to store information of distances of all golf shots in addition to the information about the course as described.

Additional features that are not illustrated but can be included in the handheld device to enhance user experience include, but are not limited to, a display, data transfer port, charger port and a device mount to mount onto a club bag or onto a golf cart. The display is preferably a touch screen color display with high resolution that allows data entry with a minimum number of external buttons, key pad or entry keys to input data. The data transfer port can be a wired port or a wireless port such as, for example, any of the wireless data transfer port using Bluetooth technology or any of the IEEE 802.11 protocols (including but not limited to a, b, g, d etc.) or IEEE 802.15 protocols, or similar, etc. There can also be a USB or fire wire data port for additional memory such as flash memory or for data transfer from the handheld device.

FIGS. 5A and 5B show two configurations of electrical components for the range finding function in an integrated ball and range finder. FIG. 5A shows electrical components responsible for using a satellite positioning system for range finding function in the integrated ball and range finder according to one embodiment of the present invention. The range finding component 520 using SPS includes a microprocessor 524 electrically coupled to a memory 522, a receiver 523 and a power source 525. The receiver 523 is also coupled to an antenna 521. Optionally, a transmitter 527 may also be electrically coupled to the microprocessor 524, the receiver 523, and the antenna 521. As described in the ball finding component, the power source 525, the microprocessor 524, and the memory 522 can all be shared between the range finding component and the ball finding component.

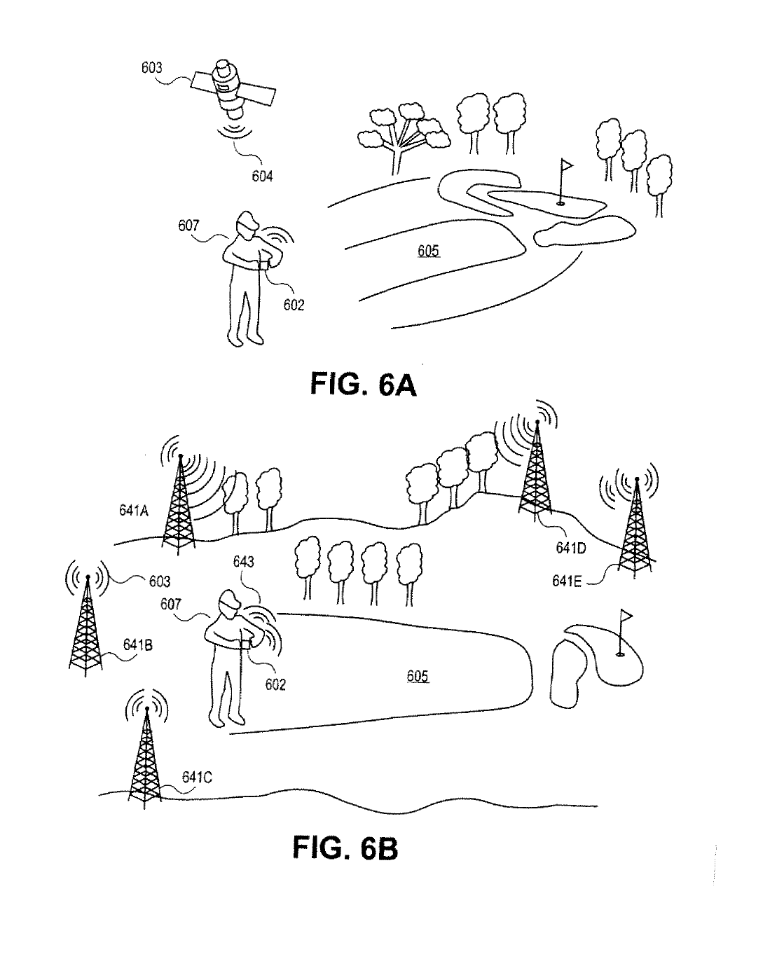

In one embodiment, the integrated ball and range finder relies on the downloading of signals to calculate positioning coordinates (longitude, latitude and/or altitude) of the device. Similar application of positioning coordinates can also be used to find tags on a flying object. One example includes the global positioning satellite system (GPS). FIG. 6A shows one embodiment of range finding using a satellite position system that relies on GPS or other earth orbiting satellites. For example, a golfer 607 on a golf course 605 holding an integrated ball and range finder 602 can receive electromagnetic signals 604 from at least three satellites 603 orbiting around the earth to determine the positioning coordinates of the handheld device. Generally, by the process of trilateration, the process of calculating the position of a point using the time difference of signal arrivals between other known points (e.g., the orbiting satellites), the handheld device can compute its longitude and latitude information using signals downloaded from three or more satellites. If the signal is received in the GPS receiver from a fourth satellite, the altitude coordinate may also be obtained. However, this method may not be very accurate because of errors introduced by internal clock (not shown) of the handheld device, and the atmospheric conditions that change the speed of the GPS signals as they pass through the ionosphere and the troposphere. The integrated ball and range finder may also use differential GPS to improve its accuracy in position location.

In another embodiment the integrated ball and range finder uses a cellular network of multiple ground transmission towers to determine the position of the device by a method such as triangulation. Similar application of positioning coordinates can also be used to find tags on a flying object. FIG. 6B shows a golfer 607 on a golf course 605 holding an integrated ball and range finding handheld device 602 that receives signals 643 from multiple fixed ground transmission towers 641 (A, B, C, D, E) located at different geographical locations on earth. Since the ground transmission towers are fixed specific locations, each transmits a unique signal representative of that specific location. Alternately, pseudolite can be used as part of the satellite positioning system. Pseudolites emit pseudo-random (PN) codes and latitude/longitude information to allow for calculation of the position. Description of Pseudolites can be found in U.S. Pat. No. 5,945,944 titled “Method and Apparatus for Determining Timing for GPS Receivers” which is hereby incorporated as reference.

In both of these embodiments, the microprocessor 524 is used to calculate the coordinates or position of the handheld device based on the differential signals received from satellites or ground transmission towers. The receiver 523 and antenna 521 are required to receive the signal while a transmitter 527 is optional. The processed signal is converted into coordinates by the microprocessor 524 and stored in the memory 522. Although other electrical components such as the microprocessor 524, the memory 522 and the power source 525 may be shared with the ball finding component, the GPS receiver, the GPS antenna are likely to be dedicated to the use of the range finding component only. The power supply, similar to the one described in the ball finding component may be rechargeable and may be in the form of lithium ion batteries or may be a non-rechargeable battery or set of batteries. Further, the power supply can be rechargeable by solar power, by the rechargeable battery powering the golf cart, or by an alternating current source. The power supply may also be a non-rechargeable battery or set of batteries. Additional components not illustrated but that can enhance user experience include, but are not limited to, a touch screen color display with high resolution, high speed data ports for additional memory or for data transfer, port for recharging the power supply, a wired or wireless data transfer port such as a port using Bluetooth technology etc., as well as device mount onto the golf cart etc. Again, these additional components will be shared with the ball finding component since the range finding component is integrated with the ball finding component in one handheld device. Both of these embodiments may be able to allow pre-selecting of a fixed object, such as the hole on the putting green, and show the distance to the front, middle, and back of the green. For example, at a tee box, based on the GPS coordinates of the portable device, the device can automatically determine the exact part of the course it is located, and can allow the golfer to select distances to various parts of the course that are predetermined.

A different method of range finding can be performed using a laser beam. This may be particularly applicable in hunting where a laser beam finder is used to determine the distance between a hunter and the target. The integrated range and tag finder can further allow a hunter to track a flying object such as an arrow after it is shot towards the target. FIG. 5B shows electrical components for using laser beam for range finding in the integrated ball and range finder according to one embodiment of the present invention. The laser beam range finding component 540 of the integrated handheld device includes a laser source 545 electrically coupled to and powered by a power source 547. The power source is controlled by a microprocessor 544. The laser 545 is also coupled to the transmitter/receiver 543, which is in turn connected to the microprocessor 544. The microprocessor is also connected to the memory 542 and the clock 548. The laser range finder operates by calculating the time elapsed between transmitting a laser beam and receiving a reflection of the laser beam back at the handheld device. The user points and aims the handheld device at a fixed object or target which is located at an unknown distance away, shoots or transmits a laser beam from the handheld device to the fixed object. The laser beam when hitting the fixed object will scatter, refract and reflect. A portion of the reflected laser beam will be received by the handheld device. The time elapsed between the transmission and receiving of the reflected laser beam is used to calculate the distance between the handheld device and the fixed object. In an integrated ball and range finder handheld device, the laser source 545 and the laser transmitter/receiver 543 are not shared with the ball finding component. The clock 548 can be dedicated solely for measuring the time elapsed for the laser beam to travel to and from the fixed object, but it may be part of the microprocessor 544 and thus can be dedicated to only the range finding component or shared with the ball finding component. Other features such as displays and data transfer ports as described earlier can also be included for an enhanced user experience. This method of using a laser beam can also be applied to a bow and arrow system or a system using a laser beam to determine the range or distance of an object from the integrated device before shooting at a target.

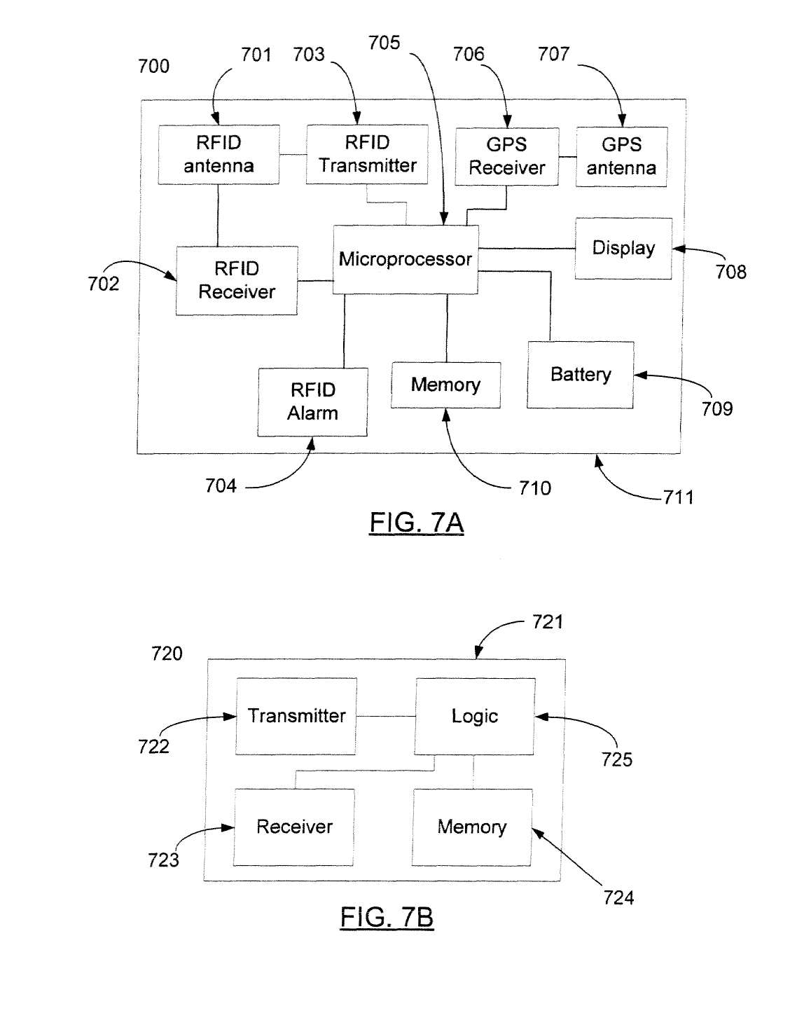

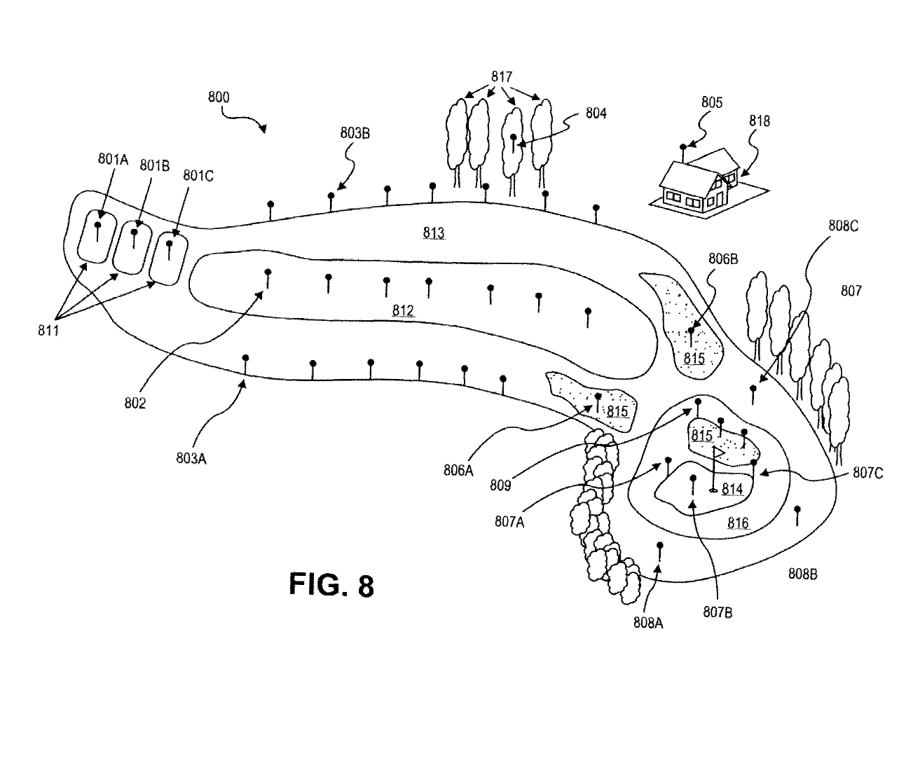

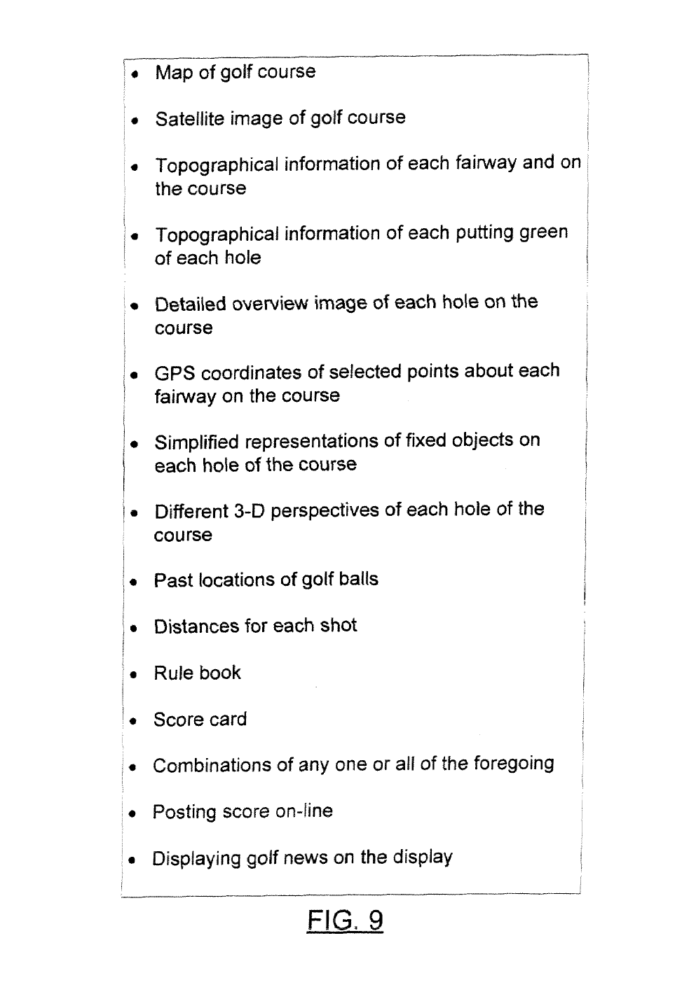

FIG. 7A shows the electrical components for a ball and range finder as one integrated handheld device in one embodiment of the present invention. This embodiment can similarly apply to, for example, a bow and arrow system, where the tag is coupled to the arrow. The electrical components in the integrated ball and range finder 700 include a microprocessor 705, a ball finding component having a RFID receiver 702, a RFID antenna 701, a RFID transmitter 703 and a RFID alarm 704, a range finding component having a GPS receiver 706, a GPS antenna 707, and several shared components that include memory 710, power source 709, and display 708. FIG. 7B shows an embodiment of a RFID transceiver 720 that may contain both transmitter 722 and receiver 723 along with logic 725 and memory 724, all in one module. This RFID transceiver 720 may replace RFID receiver 702 and RFID transmitter 703 in FIG. 7A while the additional memory 724 and processing power via logic circuit 725 can allow the module to operate independent of the shared memory 710 and shared processor 705 of the entire handheld device 700.

In an integrated handheld device 700, the RFID transmitter 703 and the RFID alarm 704 are optional components to broaden the application of the ball finding capability. For example, as described earlier in FIG. 1A, a handheld device with a transmitter can operate also with findable golf balls containing passive RFID tags, tags that does not contain a power source and cannot actively emit an electromagnetic signal. In other words, the handheld device 700 having a RFID transmitter 703 as illustrated can be compatible with findable golf balls with either active or passive RFID tags. Furthermore, the RFID alarm 704 can warn or alert the golfer of the proximity of the findable golf ball relative to the handheld device as the golfer searches for the ball. The alarm can increase in volume or pitch or frequency as the golfer moves closer to the findable golf ball to assist in the finding of the golf ball. In another embodiment, the RFID transceiver 720, including the RFID transmitter 722 or 703 and RFID receiver 723 or 702, can operate in conjunction with the logic circuit 725 and the memory 724 to program a unique personal identification onto the ball. In addition to, a quasi-unique identification as described for the findable golf ball, the user can add a personal unique identification to the findable golf ball so the golf ball can be truly unique and only respond to a uniquely programmed handheld device.

The range finding function in FIG. 7A is based on a satellite positioning system. In one embodiment, the GPS antenna 707 and GPS receiver 706 are used to receive signals from either satellites for trilateration or ground cellular transmission towers or pseudolites for triangulation. These components function independently of the ball finding portion of the device but are electrically coupled to the microprocessor 705, which is then connected to the memory 710 and power source 709 which are common with the ball finding part of the device. Operation of the range finding component to determine the position or coordinates of the handheld device is described above. Once the coordinates or the position of the handheld device is determined, the relative distance and direction between the handheld device and any fixed object on the course can be measured. There are different methods in which the distance between the handheld device and any fixed object on the golf course can be measured. In one embodiment using a satellite positioning system, the representations of fixed objects can be predetermined and recorded onto the handheld device, once the location of the handheld device is determined, it can be compared against the pre-recorded representations to determine a distance and direction.

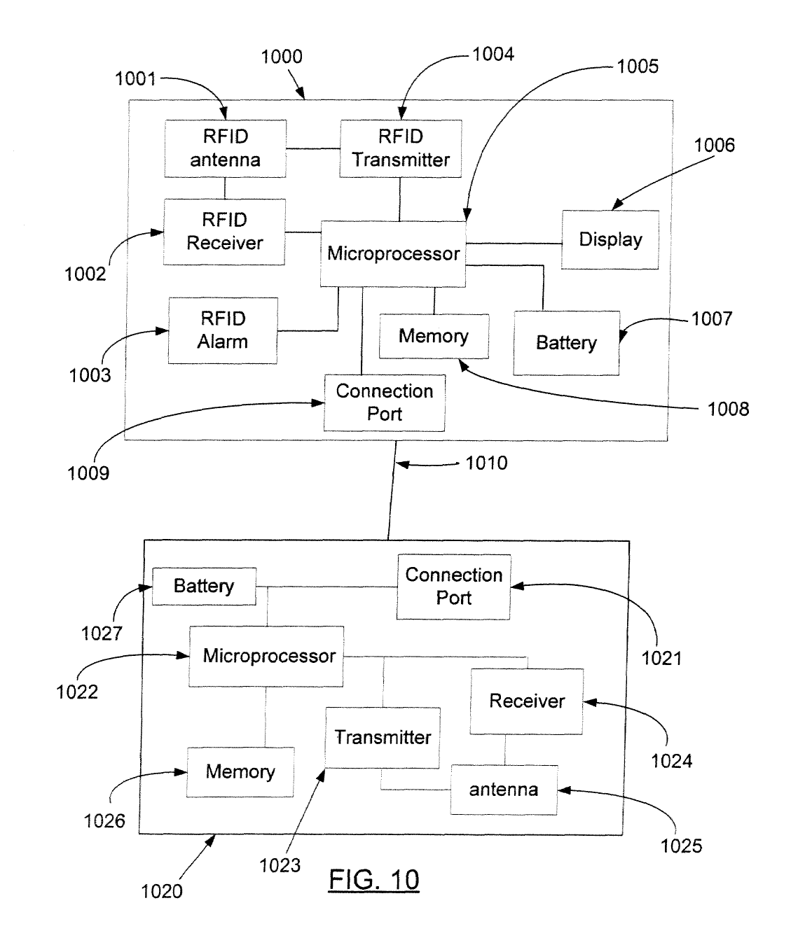

In this embodiment where positioning coordinates of the handheld device are determined by a satellite positioning system, the positioning coordinates of the fixed objects about the course are first determined. Since the objects are fixed, their coordinates do not change. Once the coordinates are determined, they can be plotted onto a map. Both the map and the coordinates can be stored electronically in the memory of the handheld device. For example, FIG. 8 shows an example of representations of predetermined locations of fixed objects about a golf course according to one embodiment of the present invention. The golf course 800 is illustrated with tee boxes 811, a fairway 812, the rough 813 with tall grass besides the fairway, hazards 815, putting green 814, the rough 816 about the putting green, and other objects such as trees 817 and a structure 818 on the course. All these objects are fixed on a golf course and can be mapped and positioned using a satellite positioning system. Different locations and parts of these objects can be mapped individually at various points and coordinates for these points determined. If the object, such as the fairway 812 is very large, more points can be determined. In other words, one or more points (coordinates) can be used as representation of the fixed object.

In the present illustration, 801A, B, C are representations of the different tee boxes at the start of the course. A series of coordinates 802 together form a representation of the fairway 812, while a series of coordinates 803A, B form a representation of the rough 813 besides the fairway. Similarly, representations 803A, B can line up near the edge of the course to mark as boundaries of the course. Furthermore, 806A, B, 807A, B, C, and 808A, B, C are representative of the hazards 815, putting green 814, and rough 816 about the putting green, respectively, while 804 and 805 represent the trees 817 on the side of the course and the structure 818 that is observed on the course. The sum of these representations of fixed objects can be overlaid on a map. The map can assist a golfer visually with an orientation of the course, while the various representations can allow the golfer to determine where the device is positioned relative to these representations on the course. The multiple representations on a golf course can also serve indirectly as yard markers. In other words, a golfer can roughly estimate the distance of the ball relative to the putting green or from the tee box simply by associating the position of the golf ball with the position of the nearest representation on the course.

In one example, after a golfer hit the ball from the tee 811 and lost it in the rough 813, the golfer can use the hand held device to locate the ball. Once the ball is found with the handheld device, while standing over the golf ball and holding the device, the golfer can determine the positioning of the device by satellite or transmission towers and compare the position of the device (essentially the same as that of the golf ball) against any other fixed object to determine the distance and direction by comparing the predetermined coordinates of those objects against the present position of the device.

In another embodiment, after losing the golf ball from a tee shot, the golfer can approach the direction of the lost ball to search for the ball using the handheld device. Once the golfer detects the lost golf ball with his handheld device, the device can determine the distance and direction of the ball relative to the device. After the ball's distance and direction is determined, the user can download the coordinates of the handheld device and compare that against the coordinate representations of the fixed object target. Using vector analysis calculations, the handheld device can calculate the distance and direction of the ball to the fixed object target. Should the ball be far away from the golf cart or the clubs, the golfer can save time by selecting the club he wants to use based on the distance and direction of the ball from the fixed object before he approaches the ball.

Pre-recording positions of fixed objects on a golf course and storing the representations of the fixed objects in the form of, for example, coordinates, can be implemented efficiently and economically. In one example, the representations can be overlaid on a map of the course so that the distances and direction of the device relative to the fixed objects can both be calculated by the microprocessor and intuitively understood by the user. For instance, the device location can be indicated as a red blinking dot on the display screen, the ball as a white dot, whereas the rest of the course is in different shades of green, and the target is a blue dot. With visual representation, the golfer can easily determine where he (or the device) and the ball are located on the map, and determine the relative distance between the device and/or the ball from any selected fixed object on the map.

Overall, the implementation of this ball and range finding system requires a shared memory (such as memory 710 in FIG. 7A) that can store a wide range of information. FIG. 9 shows an example of the content in the memory in the integrated ball and range finder in one embodiment of the present invention. The map of the golf course and the representations of the fixed objects about the course are required for the range finding component of the device. The map of the golf course can be in different views. They may include satellite imagery, a simplified representation with only different colors or shades of colors, a helicopter fly over, a simplified view represented only by GPS coordinates, and/or even a topographical layout of the terrain. Detailed topographical information showing the peaks and valleys of the fairways and breaks or slopes on the putting greens would be tremendously helpful to golfers. Satellite imagery or high resolution aerial photography or view from a fly-over of the golf course can also provide course map information to be displayed as a map on the device. Availability of different three-dimensional views and perspectives from the tee box, from various points of the fairway approaching the putting green helps with the tee and approach shots. Furthermore, having tips displayed, such as along with the putting green topographical layout, on how to make the golf shot from different parts of the green essentially functions as having an experienced caddy along side the golfer. Availability and easy access to the rule book, an accompanying electronic score card, past locations of where golf balls landed, the distance carried by the ball in each stroke, the club used to hit each stoke, and the overall path traveled by the golf ball on each hole of the course from the tee box, are extremely helpful tools, both during play as well as for post-game learning and to improve course management skills. The software application used to record such information may be integrated into the ball finding and range finding software or it can be separated. This software application if independent of the inherent ball and range finding functions of the integrated device, can be easily downloaded from a website through the connectivity or data transfer port of the device. Specifically, the map or topographical information, and the GPS coordinates of the golf course can be downloaded specifically from the website of the golf course, or through a website that collects such information about golf courses.

Other variations of an integrated ball and range finder can also be implemented. In one embodiment, both the ball finding and range finding components of the integrated handheld system can be based on RFID. This can be accomplished by placing multiple RFID readers all over the golf course and having an active or passive RFID tag in the ball. The number of readers and tags used for the implementation depends on the operating range of the RFID system. The operating range of an RFID system will obviously vary based on the sophistication of the RFID technology. In one instance, with the earlier radar based system where a handheld device transmits a signal and the passive tag in the ball doubles the frequency using a diode and transmits back to the handheld device, the range is approximately about 40 ft to about 60 ft. In a more sophisticated system, where an active tag is placed in the ball, the range of transmission of the RFID signal increases to between about 100 ft to about 150 ft. Still, in more sophisticated systems, the range of the signals can be detected at still a farther distance, to approximately about 300 ft or further. Moreover, in such a system where RFID readers are placed about a golf course, the entire system of RFID monitoring the golf course can contribute to a comprehensive system of ball and range finding while provide other advantages such as direct measurement of the ball velocity and path of travel that is made possible with the inherent RFID system capability. The number of RFID readers in such a system can be reduced as the RFID technology becomes more sophisticated and the resolution of the readers to read a traveling tag increases. Nevertheless, even with current technology, the concept of implementing such a system using a collective number of RFID readers to pin point and track a traveling RFID tag is possible with existing technology. As the RFID technology evolves, fewer readers may be used to implement in such a system. For example, in one embodiment, the course may require only three to five readers, as the range of detection increases in each reader, to operate with an active or passive or semi-passive tag in the golf ball. In a different embodiment, one reader is placed in the ball, while all the readers as previously described to be fixed at various points on the course can be replaced by tags.

The integrated ball and range finder may appear in other different embodiments. Same can be applied to, for example, an integrated range and tag finder for a tag coupled to a flying object such as an arrow. In one embodiment, a ball finder may be electrically coupled to a cellular telephone that has software to determine its location. In one example, the cell phone can be both physically and electrically coupled to the ball finder, though only electrical coupling is required to accomplish the range finding function of the integrated ball and range finder. FIG. 10 shows electrical components of a ball finder that can be electrically coupled to a cellular telephone to operate as one integrated ball and range finder. The integrated device includes a ball finding component 1000, an electrical connection 1100 between the ball finding component and the cell phone 1020. Similar to previous description, the ball finding component 1000 has a microprocessor 1005 coupled to a memory 1008, a power source (or battery) 1007, a RFID receiver 1002 and a RFID antenna 1001. In addition to those fundamental elements, there is also a display 1006, a RFID transmitter 1004 and at least one connection port 1009 for data transfer, interfacing with other devices and expansion of memory in addition to connection to the cellular phone 1020. The RFID receiver 1002, antenna 1001, microprocessor 1005, and memory 1008 are essential for the operation of the ball finding function. The connection port 1009 is responsible for connecting and electrically coupling with the cellular telephone 1020. The electrical connection allows the ball finding component's microprocessor 1005 and memory 1008 to use the positioning information gathered from the cellular telephone 1020 to determine the distance and direction of a golf ball to a fixed object using SPS coordinates. This method is described above by comparing predefined positioning information of fixed objects on the golf course. In one embodiment, the microprocessor 1005 and the memory 1008 will at least communicate with the microprocessor 1022 and memory 1026 of the cellular phone 1020.

In this illustration, the cellular phone 1020 has a microprocessor 1022 electrically coupled to a transmitter 1023, receiver 1024, antenna 1025, power source (battery) 1027, and memory 1026. These electrical components collectively act to function as a cellular telephone. The connection port 1021 allows the cellular telephone 1020 to communicate with the ball finding component 1000 by establishing an electrical connection 1010. The electrical connection 1010 can be in the form of a data cable, or it can be wireless. The wireless protocol can be, for example, an IEEE 802.11 or 802.15 based protocol, or similar, Bluetooth, or infrared etc. After communication is established between the two devices, the microprocessor 1005 in the ball finder 1000 will send a request to the microprocessor 1022 in the cellular phone 1020 to establish information of the present location or position of the cellular phone 1020. In one example, the cellular phone 1020 can retrieve its position information by triangulating signals received from at least three ground transmission towers of a cellular network of transmission towers or from SPS satellites. The information can be in the form of a GPS coordinate that includes its longitude, latitude, and altitude. In another example, the cellular phone 1020 can be pre-loaded with a software application provided by the golf course that can receive signals transmitted only from within the golf course for positional information on the premises of the golf course.

Once the positional information is obtained, the microprocessor 1005 can use the position information to compare against positional information of fixed objects already stored in the memory 1008 to determine distance and direction relative to the fixed object. In a different embodiment, the software application and predefine positional information of fixed objects can be stored in the memory 1026 of the cellular phone 1020, and the user can determine the relative distance and direction of the cellular phone 1020 relative to the fixed object by interfacing directly with the telephone. Although cellular phones 1020 are already equipped with color displays (not shown) and can display maps of the range finding application as described earlier, due to the size of the display and limited resolution, a larger display which can be available on the ball finding device, may be preferred. In another embodiment, the microprocessor 1005 and memory 1008 of the ball finding component 1000 can estimate the distance and direction of the ball from the ball finding component. In turn, the microprocessor 1005 in the ball finding component 1000 can use the positional information supplied by the cellular phone 1020 to calculate the distance and direction of the golf ball relative to a fixed object on the course, based on predefined information of the fixed objects stored on the cellular phone. In another embodiment, the cellular telephone could have both range finding and ball finding capabilities without relying on a separate portable device.

In another embodiment, the ball finding component 1000 can include another transmitter and receiver that allows direct communication with the clubhouse. For example, it can be used as an emergency communication channel. More conveniently, it can be used as a means to track the whereabouts of the golfers on the golf course, allowing golfers to place orders for food and beverages, as well as for the clubhouse to notify the golfer should weather conditions deteriorate, such as the arrival of thunder and lightning, so that golfers can be recalled back to the club house. In this embodiment, all the software applications for a range and ball finder will be pre-loaded and built into the ball finding component 1000, the cell phone will merely be used as a means to provide the location of the device or golfer on the course.

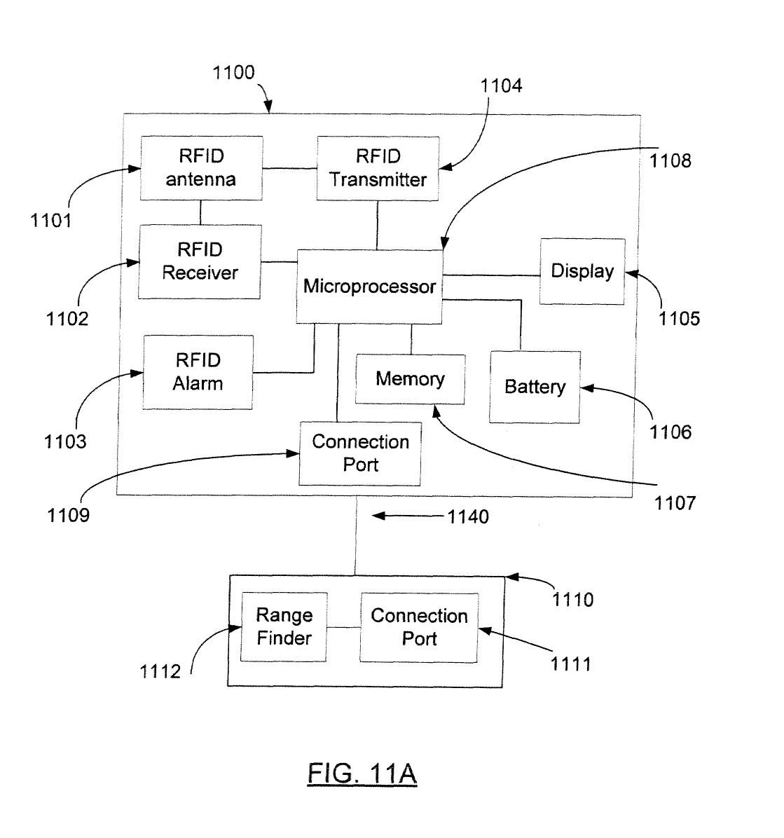

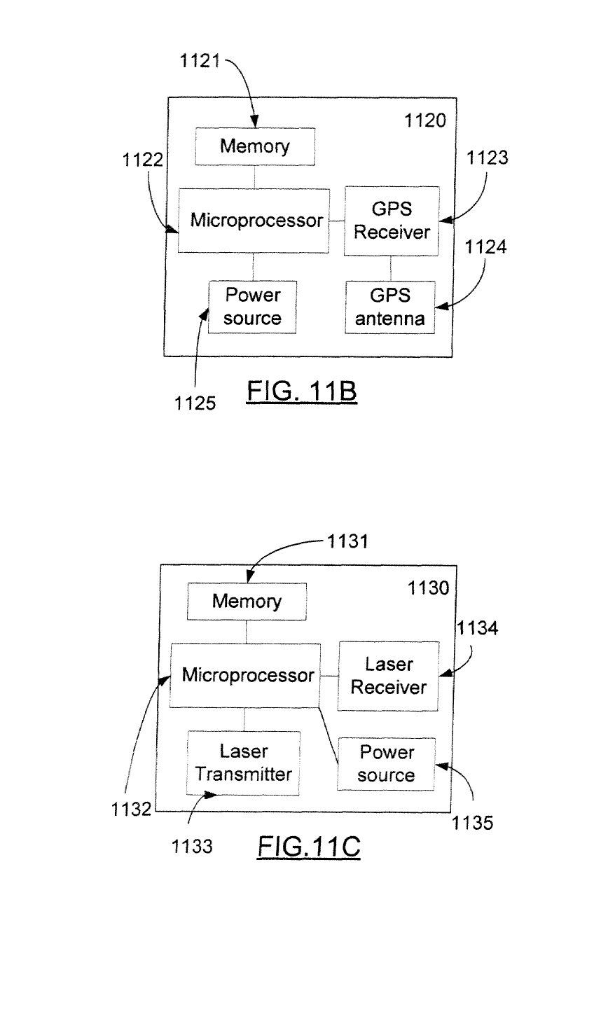

In a different embodiment, the integrated ball and range finder may include a ball finder that can be electrically coupled to a commercially available range finder such as a GPS unit on a golf cart that is provided by the golf course, or a commercially available laser range finder. A similar system can also be found in, for example, a motorized vehicle or motor bike or an all terrain vehicle which replaces a golf cart to be coupled to an integrated range and tag finder that may include at least a GPS unit. Such a combined ranger finder/ball finder could be fixed to a golf cart and be optionally removable. FIG. 11A illustrates a similar ball finding component 1100 as illustrated in FIG. 10. In FIG. 11A, The ball finding component 1100 includes a microprocessor 1108, a RFID receiver 1102, a RFID antenna 1101, a power source 1006, a connection port 1109, and a memory 1107. Optional components include the display 1105, RFID alarm 1103 and RFID transmitter 1104. The ball finding component 1100 is electrically coupled to a range finding component 1110 via a connection 1140. The connection may be a wired cable or a wireless protocol, including, but not limited to Bluetooth, any of the IEEE 802.11 protocol, or infrared. The range finder 1110 in FIG. 11A is represented by two configurations, a GPS unit 1120 (further illustrated in FIG. 11B), which may be commonly found as a separate handheld unit, or as a part of a golf cart equipped with a GPS system, or as a commercially available laser range finder 1130 (further illustrated in FIG. 11C).

One embodiment consists of the combination of the ball finding component 1100 and the GPS unit 1120 of a golf cart. The method of determining the distance and direction relative to an object relies upon comparing the GPS or positional information of the golf cart with respect to the predefined coordinates of the fixed objects as predetermined and stored in either the memory 1121 of the GPS unit (as illustrated in FIG. 11B) or the memory 1107 of the ball finding device (as illustrated in FIG. 11A). The former memory 1121 is most convenient since it will most likely already contain mapping information for the golfer using the cart. The ball finding component 1100 of FIG. 11A can be combined with the GPS unit 1120 in the golf cart to determine the distance and direction of the golf ball by calculations once the ball position is located by the ball finder 1100. Preferably, if a ball finder component 1100 in FIG. 11A is to be combined and integrated with the GPS unit 1120 on a golf cart, the ball finder component can also be mounted onto the golf cart for easy access and for placement during operation of the golf cart. Furthermore, as described earlier, the GPS unit 1120 in FIG. 11B or the ball finding component 1100 in FIG. 11A can not only have access to each other's memory, they can also synergistically utilize the microprocessors in each other for distance and direction calculations or for other functions. Either component can also include a transmitter/receiver to allow for communication with the clubhouse. The connection ports 1109 and 1111 in the ball finder and the GPS unit in FIG. 11A can serve not only as a way of communicating to each other, but additional ports can also be present to increase memory or communicate with other devices.

In another embodiment, a ball finding component 1100 as described above in FIG. 11A, is combined with a laser range finder 1130 as shown in FIG. 11C. The operation of a laser range finder 1130 is described above. The laser range finder 1130 has a microprocessor 1132 with a clock (not shown) to measure the time elapsed between transmitting a laser beam from the transmitter 1133 that is being reflected back from hitting a fixed object into the receiver 1134. There may also be a memory 1131 to store previous measurements or other related information. Different kinds of commercial laser range finders are available but they cannot be used to find golf balls. A smart ball finder 1100 can be combined with the laser range finder either physically and/or electrically coupled, to minimize the number of devices a golfer has to carry. Together, the combined device can calculate the distance and direction of a golf ball from a target once the golf ball is detected without having the golfer stand at the golf ball to use the laser finder to measure the distance directly from the spot of the golf ball.

Still in another different embodiment, an integrated ball finder having a ball finder and a laser range finder component housed together in one casing can be used in combination with a GPS unit on a golf cart. The advantage of a golf cart GPS unit combined with a ball finder is to provide the GPS positioning of golf cart at all times. The distance of the ball from the fixed object still has to be calculated based on the ball finder locating the ball and distance of the cart from the targeted fixed object. Since the information of a fixed object is generally represented by a coordinate and unless many representations are taken of a large fixed object, for example, multiple points on a putting green, the distance from the ball to where the golfer wants to hit his ball is still relatively inaccurate. With the availability of a laser range finder, the golfer has the option of measuring directly the distance of the ball to the exact location where he wants to target his golf shot and therefore provide a more precise and accurate distance measurement.

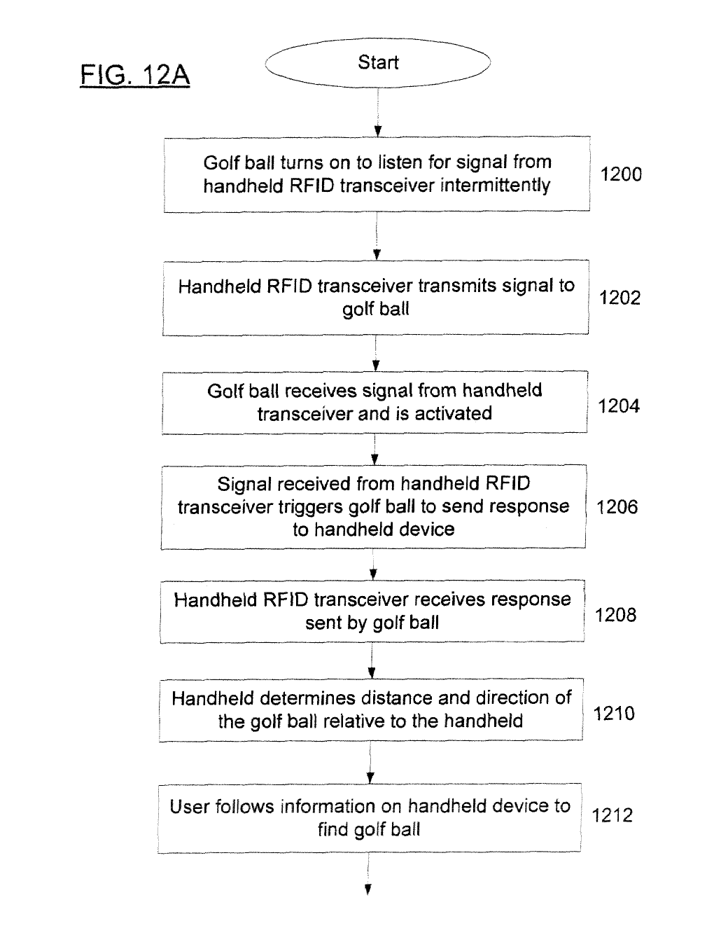

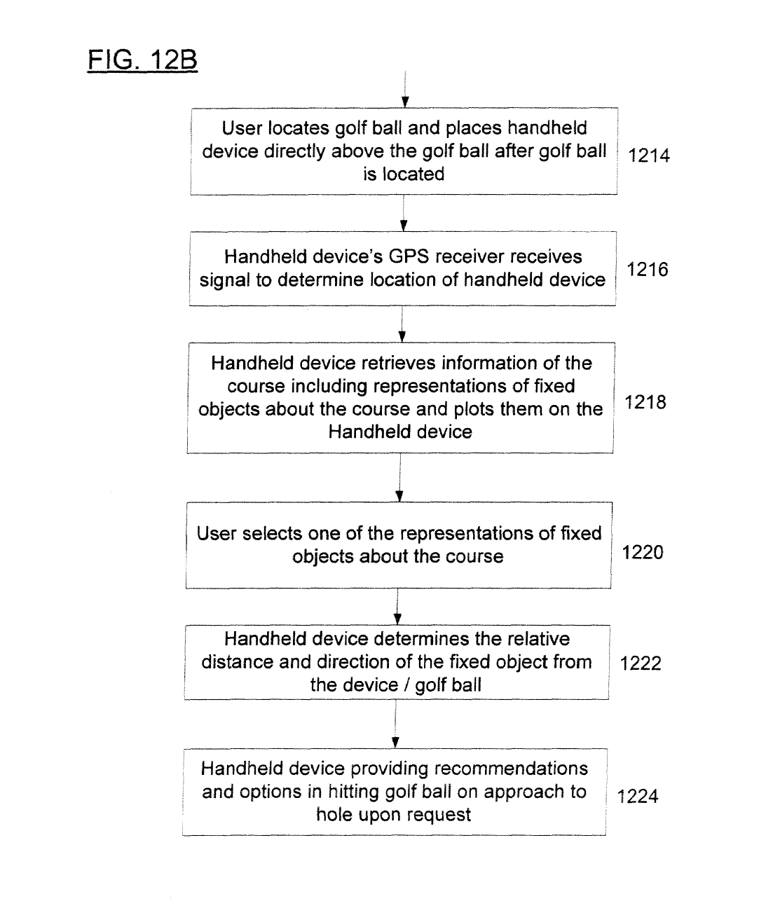

FIGS. 12A and 12B show a flow chart of the operation of an integrated range and ball or tag finder in one embodiment of the present invention. The method shown in FIGS. 12A and 12B is generally applicable to any type of RFID based golf ball. In addition, although the example uses a SPS based range finder to determine distance from the device to a fixed object, it can be replaced by a laser range finder as will be explained further. The method of finding a golf ball in FIG. 12A begins with 1200 having the microprocessor in the golf ball controlling the period when the golf ball triggers on and triggers off. The shorter the duration between on and off, the more power the golf ball consumes because of the energy it requires to power the receiver and to transmit a signal. In other words, the power consumption of the golf ball with a microprocessor that controls signal transmission may be optionally programmed and determined by the user. Thus, while this period will often be predetermined in the factory, sophisticated examples may be modifiable by the user. One means of adjusting the power consumption of the golf ball is to adjust the transmission signal strength of an active RFID tag located inside the ball. For example, a user may decide that the course is wide open, containing few obstructions, thus less likely to have any obstruction come between him and the golf ball and so he does not have a strong signal to locate a ball. On the contrary, for a golf course with many obstructions such as tall grass and shrubbery, a golfer may want to increase the transmission signal strength before hitting the golf ball to ensure that he can find the ball if it lands amongst the tall grass and shrubbery. When the ball is out of sight, the user can transmit a signal from the handheld device near the proximity of where the ball was last seen as in 1202. Similarly, the strength of the signal transmitted may also be adjusted to compensate for the amount of obstructions present on the course. Once the golf ball has received the signal from the handheld device, it becomes activated as shown in 1204. The activated golf ball in turn will transmit a signal to the handheld device to communicate its position to the handheld device.

In one embodiment, the golf ball only intermittently turns itself on to listen for the handheld device, however, once it receives the transmitted signal from the handheld device, the golf ball will remain turned on either continuously or will be turned on much longer than it is turned off, until the user finds a ball and sends a different signal to deactivate the golf ball. In another embodiment, the golf ball operates in reverse and is activated or turned on at all times unless it is being turned off by a special signal sent from the handheld device.

Once the handheld device receives the response sent by the golf ball, as shown in 1208, the handheld device will then determine the distance and direction of the golf ball relative to the handheld device, as shown in 1210. Generally, the strength of the signal received by the handheld device transceiver is used to determine the distance and direction of the golf ball from the handheld device. In the embodiments where the signal strength of the ball can be adjusted, the handheld device will equally calibrate its receiver to adjust for the ball's increased signal strength when calculating the distance of the golf ball. Once the direction and/or the distance of the golf ball is determined, the golfer can follow the directions or positional information determined by the handheld device to find the golf ball as in 1212.

The method of determining a distance from the golf ball relative to a fixed object in FIG. 12B is generally applicable to either a SPS based range finder or a laser range finder, though the former is illustrated. In either case, finding a distance begins first with locating the golf ball and holding the handheld device over or within a reasonably close proximity of the golf ball as shown in 1214. The user then activates the SPS or GPS receiver of the handheld device to retrieve the positional information of the handheld device as in 1216. With the positional information of the handheld device available, the handheld device can retrieve the positional representations of the fixed objects about the golf course and plot them on a display, or preferably, overlay them on top of a map of the course as in 1218. The golfer can then select one of the representations of the fixed objects on the course, as in 1220 or a fixed object may already be pre-selected based upon the location of the handheld device, and calculate the distance and direction of the fixed object relative to the handheld device using the positional information of the handheld device and the positional representations of the fixed objects. With the SPS system as illustrated, the distance and direction can easily be calculated based on the difference of the longitude, latitude, and altitude coordinates of the handheld device and the fixed object(s), as shown in 1222. In one embodiment, based on the distance between the ball and the fixed object, information about the golf course such as topographical information, hazards near the target, and the golfer's driving distances with different clubs, the handheld device can provide recommendations and tips in club selection and/or preferable way to approach the target as shown in 1224.

In a different embodiment of using a laser range finder, the golfer/user will still begin by first locating the golf ball and positioning the integrated handheld device above or near the proximity of the golf ball as in 1214. However, in place of the steps illustrated in 1216 to 1222, the golfer simply points and aims the device's laser transmitter to a fixed object, shoot transmit a laser beam to that fixed object and wait for the laser beam to be reflected and received by the handheld device. The elapsed time will allow the handheld device to calculate the distance between the handheld device and the fixed object. As far as recommendations and options, the handheld device can still store in its memory the topographical, environmental and general course information specific to each part of the course and the user can retrieve them independently for each part of the course.

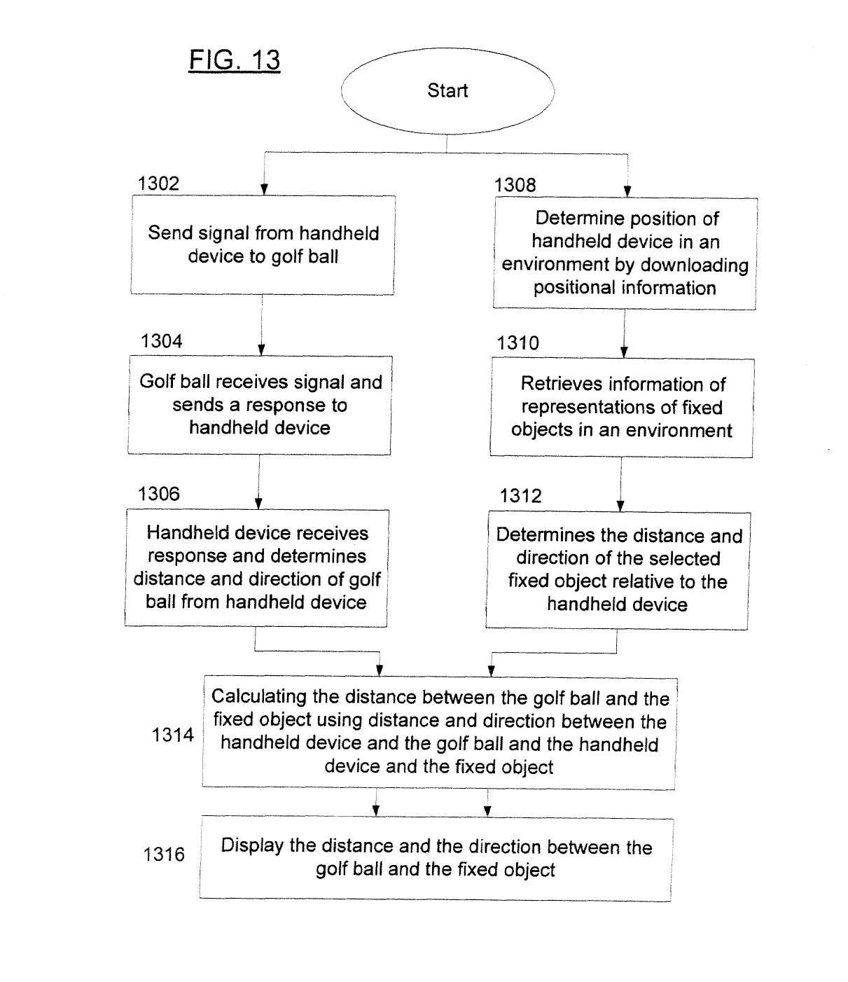

A method to determine the distance and direction of a golf ball from a fixed object without physically being at the golf ball is also possible, such a method is illustrated in FIG. 13 with an integrated ball finder that uses RFID technology to locate the golf ball and an SPS based ranger finder component. Both the steps in finding a golf ball and determining a distance are similar to the steps illustrated in FIGS. 12A and 12B. The method begins with the user sending a signal to a golf ball to search for the golf ball as shown in 1302, once the golf ball receives the signal, it will send a response back to the handheld device in 1304. In turn, the handheld device is able to determine the distance and direction of the golf ball relative to the handheld device based on the signal strength of the golf ball in 1306. Without having to actually retrieve the golf ball, the user can immediately download the positional information of the handheld device as in 1308. The golfer/user then retrieves information of the positional representations of the fixed objects about the golf course in 1310. In 1312, the golfer/user selects a fixed object or a positional representation of a fixed object and asks the handheld device to determine the distance between the handheld device and the fixed object. Using the distance and direction information obtained of the golf ball from the handheld device, and the distance and direction information of the fixed object from the handheld device, the distance and direction of the fixed object from the golf ball can be determined, as shown in 1314. This distance and direction can then be displayed on the handheld device upon request, as shown in 1316. This method can also apply to a range finder using a laser system, but the measurement may contain a larger error because the vector coordinates of the ball, the handheld device, and the fixed object are less accurately defined, and thus rendering the calculations to be subjected to greater error.

It should be noted that at least some if not all of the above embodiments are applicable in at least the activities of hunting with a bow and arrow, hunting with gun and bullets, and flying model rockets and model airplanes. In these activities, a tag may be coupled to the flying object (arrow, bullet, model rocket or model airplane) so that the flying object can be tracked and located using an integrated range and tag finder. It should be noted that the combined range and tag finder, one integrated device, may comprise an RFID component for finding the tag or flying object, and may use a satellite positioning system or a laser beam or the RFID system or a combination of any of the three for range finding.

In the foregoing specification, the invention has been described with reference to specific examples. It will be evident that various modifications may be made thereto without departing from the broader spirit and scope specified by the following claims. The specification and drawings are accordingly to be regarded in an illustrative sense rather than a restrictive sense.

What is claimed is:

1. A system for measuring distance and for locating an object, the object having a semiconductor which is coupled to an antenna and both the semiconductor and the antenna are coupled to the object, the system comprising:
a first receiver to receive a first response from the object;
the first receiver to determine information about a location of the object which comprises at least one of a first direction and a first distance from the first receiver to the object;
a second receiver to receive a second signal;
the second receiver to determine information about a location of the second receiver; and
at least one processor coupled to the first receiver and to the second receiver to determine at least one of a second direction and a second distance between the second receiver and at least one of other objects in an environment.

2. The system as in claim 1 wherein the object is a flying object that includes at least one of an arrow and a bullet and a golf ball.

3. The system as in claim 1 wherein both the semiconductor and the antenna are detachedly coupled to the object.

4. The system as in claim 1 wherein the first receiver further comprises at least one of a RFID receiver and a laser beam receiver and the second receiver comprises a Satellite Positioning System receiver.

5. The system as in claim 1 wherein the first receiver is contained within a handheld device and the environment is a predefined environment of a golf course and the other objects are fixed objects in the predefined environment and the object is a golf ball.

6. The system of claim 5 wherein the handheld device further comprises a touch screen display.

7. The system of claim 5 wherein the first receiver is a RFID receiver and the handheld device further comprises a RFID antenna, and wherein the first receiver is coupled to a first transmitter to form a transceiver capable of transmitting and receiving information from the golf ball and the transceiver is a RFID transceiver, and wherein the second receiver is a GPS satellite receiver and the handheld device further comprises a GPS antenna and the second receiver is contained within the handheld device.

8. The system of claim 7 wherein the fixed objects further comprise at least one of a flag pole on a putting green, sand traps, trees, bushes, a golf hole, a putting green, patches of rough grass, a front of a green, and a back of a green.

9. The system of claim 8 wherein the handheld device further comprises a memory, wherein the memory stores at least one of map of a golf course, topographical information of the golf course and representative information of locations of certain fixed objects on the golf course.

10. The system of claim 9 wherein the handheld device further comprises a rechargeable power source or a non-rechargeable power source.

11. The apparatus of claim 10 wherein the rechargeable power source is rechargeable by at least one of a battery in a golf cart, solar power, and an AC power source and wherein the handheld device further comprises a wireless transceiver to communicate with a wireless cellular telephone.

12. The apparatus of claim 11 wherein the first response of the golf ball possesses an identification of the golf ball.

13. The apparatus of claim 10 wherein the at least one processor is capable of determining at least one of a third direction and a third distance from the golf ball to any of the fixed objects in the environment.

14. The apparatus of claim 10 wherein the handheld device further comprises a cellular telephone.

15. A method for measuring distance and for locating a golf ball, comprising:
receiving a response in a first receiver from said golf ball having a semiconductor coupled to an antenna that is within a predefined environment;
determining at least one of a first distance and a first direction of said golf ball relative to a handheld device;
receiving a second signal in a second receiver;
determining information about a location of the handheld device from the second signal; and
measuring at least one of a second distance and a second direction of said handheld device relative to at least one of a plurality of fixed objects within the environment.

16. The method of claim 15 further comprising sending a signal from the handheld device to the golf ball before receiving the response from the golf ball.

17. The method of claim 16 further comprising activating a circuit in the golf ball to detect the handheld device prior to the sending of the signal from the handheld device, and wherein the handheld device further comprises a display.

18. The method of claim 27 wherein the first receiver is a RFID receiver and the handheld device further comprises a RFID antenna, and wherein the first receiver is coupled to a first transmitter to form a transceiver capable of transmitting and receiving information from the golf ball, wherein the transceiver is a RFID transceiver, and wherein the second receiver is a GPS satellite receiver and the handheld device further comprises a GPS antenna, and wherein the environment is predefined and is a golf course and the fixed object further comprises at least one of a flag pole on a putting green, sand traps, trees, bushes, a golf hole, a putting green, patches of rough grass, a front of a green, and a back of a green.

19. The method of claim 18 wherein the handheld device further comprises a memory, wherein the memory stores at least one of a map of a golf course, topographical information of the golf course and GPS coordinates of certain fixed objects on the golf course.

20. The method of claim 19 wherein the handheld device is a cellular telephone.

21. The method of claim 19 wherein the handheld device further comprises a rechargeable power source and wherein the rechargeable power source is rechargeable by at least one of a battery in a golf cart, solar power, and an AC power source.

22. The method of claim 19 wherein at least one processor coupled to the first receiver and the second receiver is capable of determining at least one of a third direction and a third distance from the golf ball to the fixed object in the environment.

23. An apparatus for measuring distance and for locating a golf ball, comprising:
a portable device, further comprising:
a first receiver to receive a first response from the golf ball;
the first receiver to determine information about a location of the golf ball which comprises at least one of a first direction and a first distance from the portable device to the golf ball;
a cellular telephone electrically coupled to the portable device;
the portable device further comprising at least one processor electrically coupled to the cellular telephone, and wherein at least one of the cellular telephone and the at least one processor having the capability to determine at least one of a second direction and a second distance from said cellular telephone and at least one of many fixed objects in a predefined environment.

24. The apparatus of claim 23 wherein the portable device further comprises a display.

25. The apparatus of claim 23 wherein the portable device further comprises a memory, the memory storing representations of the location of the predefined environment and representations of locations of the fixed objects in the predefined environment.

26. The apparatus of claim 23 wherein at least one of the cellular telephone and the at least one processor further having the capability to determine at least one of a third direction and a third distance from the golf ball to the fixed object in the predefined environment and wherein the cellular telephone comprises a satellite positioning system receiver to determine the position of the cellular telephone.

27. The apparatus of claim 23 wherein the portable device is coupled to the cellular telephone by a wireless connection.

28. The apparatus of claim 23 wherein the portable device is coupled to the cellular telephone by a wired connection and the portable device and the cellular telephone are in the same housing.

29. The apparatus of claim 55 wherein the first receiver is a RFID receiver and the portable device further comprises a RFID antenna, and wherein the first receiver is coupled to a first transmitter to form a first transceiver, wherein the first transceiver is a RFID transceiver.

30. An apparatus for measuring distance and for locating a golf ball, comprising:
a handheld device, further comprising:
a first receiver to receive a first response from the golf ball;
the first receiver to determine information about a location of the golf ball which comprises at least one of a first direction and a first distance from the handheld device to the golf ball;
a range finding device electrically coupled to the handheld device;
the range finding device is coupled to a movable object in a predefined environment;
the range finding device having capability to determine at least one of a second direction and a second distance between said range finding device and a fixed object in the predefined environment; and
the handheld device further comprising at least one processor electrically coupled to the range finding device.

31. The apparatus of claim 30 wherein the handheld device further comprises a display, and wherein the first receiver is a RFID receiver and the handheld device further comprises a RFID antenna, and wherein the first receiver is coupled to a first transmitter to form a first transceiver, wherein the first transceiver is a RFID transceiver, and wherein the predefined environment is a golf course and the fixed object is one of (a) a hole on a green; (b) a front of the green and (c) a back of the green, and wherein the moveable object is one of (a) a person; (b) a motorized golf cart, and (c) a golf bag and wherein the handheld device and the range finding device are contained in the same housing.

32. The apparatus of claim 30 wherein the handheld device, in a first housing, is coupled to the range finding device, in a second housing, by a wireless connection and wherein the first housing and the second housing are separate and distinct.

33. The apparatus of claim 30 wherein the range finding device further comprises a memory, the memory storing representations of locations of the predefined environment and representations of locations of the fixed object in the predefined environment, and wherein the range finding device further comprises a second receiver to receive a second signal to determine a position of the range finding device within the predefined environment, and wherein the at least one processor further having the capability to determine at least one of a third direction and a third distance from the golf ball to the fixed object in the predefined environment.

34. An apparatus for measuring distance and for locating an object, comprising:
a portable device, further comprising:
a first receiver to receive a first response from the object;
the first receiver to determine information about a location of the object which comprises at least one of a first direction and a first distance from the portable device to the object,
a cellular telephone electrically coupled to the portable device;
the portable device further comprising at least one processor electrically coupled to the cellular telephone; and
the at least one processor having the capability to determine at least one of a second direction and a second distance from said cellular telephone and at least one of many fixed objects in a predefined environment.

35. The apparatus as in claim 34 wherein the object is a flying object that includes at least one of an arrow and a bullet and a golf ball.

36. The apparatus as in claim 34 wherein the first receiver is at least one of a RFID receiver and a laser beam receiver.
